(19) United States
(12) Patent Application Publication
(10) Pub. No.: US 2024/0096276 A1
(43) Pub. Date: Mar. 21, 2024

(54) GATE DRIVING CIRCUIT

(71) Applicant: SAMSUNG DISPLAY CO., LTD., YONGIN-SI (KR)

(72) Inventors: Minwoo Byun, YONGIN-SI (KR); Junyong AN, YONGIN-SI (KR); Soongi KWON, YONGIN-SI (KR); Junyoung MIN, YONGIN-SI (KR); Junwon CHOI, YONGIN-SI (KR); Chaehan HYUN, YONGIN-SI (KR)

(21) Appl. No.: 18/465,486

(22) Filed: Sep. 12, 2023

(30) Foreign Application Priority Data
Sep. 19, 2022 (KR) 10-2022-0118109
Nov. 18, 2022 (KR) 10-2022-0155798

(51) Int. Cl. G09G 3/3225; G09G 3/32

(52) U.S. Cl. CPC G09G 3/3225; G09G 3/32; G09G 2300/0426

(57) ABSTRACT

Each of a plurality of stages of a gate driving circuit includes a first node controller configured to control voltage levels of a first node and a second node, a second node controller configured to control a voltage level of a third node, and a first output unit configured to output the first voltage or the second voltage as a gate signal according to the voltage levels of the second node and the third node. The first node controller includes a single gate transistor having one gate and a dual gate transistor having a pair of gates disposed in different layers with a semiconductor disposed therebetween.

### CROSS-REFERENCE TO RELATED APPLICATION

This application claims priority under 35 U.S.C. § 119 to Korean Patent Application No. 10-2022-0118109, filed on Sep. 19, 2022, and Korean Patent Application No. 10-2022-0155798, filed on Nov. 18, 2022, the disclosures of which are incorporated by reference herein in their entireties.

### TECHNICAL FIELD

Embodiments of the present disclosure relate to a display apparatus, and more particularly, to a gate driving circuit that outputs a gate signal and a display apparatus including the gate driving circuit.

### DISCUSSION OF RELATED ART

A display apparatus may include, for example, a pixel unit including a plurality of pixels, a gate driving circuit, a data driving circuit, and a controller. The gate driving circuit may include a plurality of stages respectively connected to a plurality of gate lines. The stages may respectively provide gate signals through the gate lines connected thereto in response to signals from the controller.

### SUMMARY

Embodiments of the present disclosure include a gate driving circuit that may stably output a gate signal, and a display apparatus including the gate driving circuit.

According to an embodiment, a gate driving circuit includes a plurality of stages. Each of the plurality of stages includes a first node controller configured to control a voltage level of a first node and a voltage level of a second node, a second node controller configured to control a voltage level of a third node, and a first output unit connected between a first voltage input terminal to which a first voltage is input and a second voltage input terminal to which a second voltage is input, and configured to output the first voltage or the second voltage as a gate signal according to the voltage levels of the second node and the third node. The first node controller includes a first transistor connected between an input terminal to which a start signal is input and the first node, and including a gate connected to a first clock terminal to which a first clock signal is input, a second transistor connected between the first node and a third voltage input terminal to which a third voltage is input, and including a first gate and a second gate which are connected to the third node, and a third transistor connected between the first node and the second node, and including a gate connected to the first voltage input terminal. The first gate and the second gate of the second transistor may be disposed in different layers with a semiconductor disposed therebetween.

In an embodiment, a voltage level of the first voltage is greater than a voltage level of the second voltage, and a voltage level of the third voltage is less than the voltage level of the second voltage.

In an embodiment, the first transistor includes a plurality of sub-transistors connected in series with each other, and a gate of each of the plurality of sub-transistors is connected to the first clock terminal.

In an embodiment, the second transistor includes a plurality of sub-transistors connected in series with each other, and a first gate and a second gate of each of the plurality of sub-transistors are connected to the third node.

In an embodiment, each of the first transistor and the second transistor includes a pair of sub-transistors connected in series with each other, and each of the plurality of stages further includes a leakage prevention transistor including a gate connected to the first node, and including a first end connected to the first voltage input terminal and a second end connected to an intermediate node of the pair of sub-transistors.

In an embodiment, the first node controller further includes a fourth transistor connected between the second node and a second clock terminal to which a second clock signal is input, and including a gate connected to the second node, and a first capacitor connected between the second node and the fourth transistor. The first clock signal and the second clock signal may repeat a voltage of a first voltage level and a voltage of a second voltage level, and the second clock signal may be shifted by a half cycle from the first clock signal.

In an embodiment, the second node controller includes a fourth transistor connected between the third node and the third voltage input terminal, and including a first gate connected to the first node and a second gate connected to the third voltage input terminal.

In an embodiment, the second node controller further includes a fifth transistor connected between the first clock terminal and a fourth node, and including a gate connected to the first node, a sixth transistor connected between the first voltage input terminal and the fourth node, and including a first gate and a second gate which are connected to the first clock terminal, a seventh transistor connected between the fourth node and a fifth node, and including a gate connected to the first voltage input terminal, a capacitor connected between the fifth node and a sixth node, an eighth transistor connected between a second clock terminal to which a second clock signal is input and the sixth node, and including a gate connected to the fifth node, and a ninth transistor connected between the first voltage input terminal and the third node, and including a first gate and a second gate which are connected to the sixth node. The first clock signal and the second clock signal repeat a voltage of a first voltage level and a voltage of a second voltage level, and the second clock signal is shifted by a half cycle from the first clock signal.

In an embodiment, the first output unit includes a first pull-up transistor connected between the first voltage input terminal and a first output node, and including a gate connected to the second node, and a first pull-down transistor connected between the second voltage input terminal and the first output node, and including a gate connected to the third node.

In an embodiment, the first output unit includes a first pull-up transistor connected between the first voltage input terminal and a first output node, and including a first gate and a second gate which are connected to the second node, and a first pull-down transistor connected between the second voltage input terminal and the first output node, and including a first gate and a second gate which are connected to the third node. The first gate and the second gate of each of the first pull-up transistor and the first pull-down transistor are disposed in different layers with a semiconductor disposed therebetween.

In an embodiment, each of the plurality of stages further includes a second output unit connected between the first voltage input terminal and the second voltage input terminal, and is configured to output the first voltage or the second voltage as a carry signal according to the voltage levels of the second node and the third node.

In an embodiment, the second output unit may include a pull-up transistor connected between the first voltage input terminal and a second output node, and including a first gate and a second gate which are connected to the second node, and a pull-down transistor connected between the second voltage input terminal and the second output node, and including a first gate and a second gate which are connected to the third node. The first gate and the second gate of each of the pull-up transistor and the pull-down transistor are disposed in different layers with a semiconductor disposed therebetween.

In an embodiment, a start signal of a first stage among the plurality of stages is an external signal, and start signals of second and later stages among the plurality of stages are carry signals output from a preceding stage.

In an embodiment, on-times of the gate signal and the carry signals are greater than an on-time of the external signal.

In an embodiment, a timing when an on-time of the start signal of the first stage starts is the same as a timing when an on-time of a first gate signal output from the first stage starts, and a timing when an on-time of a gate signal output from each of the second and later stages starts is delayed by a certain time from a timing when an on-time of a start signal of each of the second and later stages starts.

In an embodiment, each of the plurality of stages further includes a reset transistor connected between the first node and the second voltage input terminal, and configured to reset the first node, and the reset transistor includes a first gate and a second gate which are connected to a reset terminal to which a reset signal is input.

According an embodiment of the present disclosure, a gate driving circuit includes a plurality of stages, and each of the plurality of stages includes a first node controller configured to control a voltage level of a first node and a voltage level of a second node, a second node controller configured to control a voltage level of a third node, and a first output unit connected between a first voltage input terminal to which a first voltage is input and a second voltage input terminal to which a second voltage is input, and configured to output the first voltage or the second voltage as a gate signal according to the voltage levels of the second node and the third node. The first node controller includes a first transistor including a pair of first sub-transistors connected in series with each other between an input terminal to which a start signal is input and the first node, and including a gate of each of the first sub-transistors connected to a first clock terminal to which a first clock signal is input, a second transistor including a pair of second sub-transistors connected in series with each other between the first node and a third voltage input terminal to which a third voltage is input, and including a gate of each of the second sub-transistors connected to the third node, and a third transistor connected between the first node and the second node, and including a gate connected to the first voltage input terminal. A voltage level of the first voltage is greater than a voltage level of the second voltage, and a voltage level of the third voltage is less than the voltage level of the second voltage.

In an embodiment, each of the plurality of stages further includes a leakage prevention transistor including a gate connected to the first node, and including a first end connected to the first voltage input terminal and a second end connected to an intermediate node of the first sub-transistors and an intermediate node of the second sub-transistors.

In an embodiment, the second node controller further includes a fourth transistor connected between the first clock terminal and a fourth node, and including a gate connected to the first node, a fifth transistor connected between the first voltage input terminal and the fourth node, and including a gate connected to the first clock terminal, a sixth transistor connected between the fourth node and a fifth node, and including a gate connected to the first voltage input terminal, a capacitor connected between the fifth node and a sixth node, a seventh transistor connected between a second clock terminal to which a second clock signal is input and the sixth node, and including a gate connected to the fifth node, an eighth transistor connected between the first voltage input terminal and the third node, and including a gate connected to the sixth node, and a ninth transistor connected between the third node and the third voltage input terminal, and including a gate connected to the first node. The first clock signal and the second clock signal repeat a voltage of a first voltage level and a voltage of a second voltage level, and the second clock signal is shifted by a half cycle from the first clock signal.

In an embodiment, each of the plurality of stages further includes a second output unit connected between the first voltage input terminal and the second voltage input terminal, and is configured to output the first voltage or the second voltage as a carry signal according to the voltage levels of the second node and the third node.

### BRIEF DESCRIPTION OF THE DRAWINGS

The above and other features of the disclosure will become more apparent by describing in detail embodiments thereof with reference to the accompanying drawings, in which:

FIG. 1 is a schematic diagram illustrating a display apparatus according to an embodiment;

FIG. 2 is a schematic diagram illustrating a gate driving circuit according to an embodiment;

FIG. 3 is a schematic diagram illustrating a gate driving circuit according to an embodiment;

FIG. 4 is a timing diagram of input/output signals of the gate driving circuit of FIG. 3 according to an embodiment;

FIG. 5 is a circuit diagram of an example of a stage constituting the gate driving circuit of FIG. 3;

FIGS. 6A and 6B are timing diagrams showing an example of an operation of the stage illustrated in FIG. 5;

FIGS. 7 to 9 are circuit diagrams showing various modified examples of a stage circuit according to an embodiment;

FIG. 10 is a schematic diagram illustrating a gate driving circuit according to an embodiment;

FIG. 11 is a schematic timing diagram of gate signals output by the gate driving circuit of FIG. 10 according to an embodiment;

FIG. 12 is a schematic block diagram of a display apparatus according to an embodiment;

FIG. 13 is a circuit diagram of a pixel of FIG. 12 according to an embodiment;

FIG. 14 is a schematic timing diagram of gate signals output by a gate driving circuit of FIG. 12 to a pixel of FIG. 12 according to an embodiment;

FIG. 15 is a schematic block diagram of a display apparatus according to an embodiment;

FIG. 16 is a circuit diagram showing an example of the pixel of FIG. 15;

FIG. 17 is a schematic timing diagram of gate signals output by the gate driving circuit of FIG. 15 to a pixel of FIG. 16 according to an embodiment;

FIG. 18 is a circuit diagram showing an example of the pixel of FIG. 15 according to an embodiment; and

FIG. 19 is a schematic timing diagram of gate signals output by the gate driving circuit of FIG. 15 to a pixel of FIG. 18 according to an embodiment.

### DETAILED DESCRIPTION

Embodiments of the present disclosure will be described more fully hereinafter with reference to the accompanying drawings. Like reference numerals may refer to like elements throughout the accompanying drawings.

As used herein, the term “and/or” includes any and all combinations of one or more of the associated listed items. Throughout the disclosure, the expression “at least one of a, b or c” indicates only a, only b, only c, both a and b, both a and c, both b and c, all of a, b, and c, or variations thereof.

It will be understood that the terms “first,” “second,” “third,” etc. are used herein to distinguish one element from another, and the elements are not limited by these terms. Thus, a “first” element in an embodiment may be described as a “second” element in another embodiment.

It should be understood that descriptions of features or aspects within each embodiment should typically be considered as available for other similar features or aspects in other embodiments, unless the context clearly indicates otherwise.

The terms of a singular form may include plural forms unless the context clearly indicates otherwise.

It will also be understood that the terms “comprises,” “includes,” and “has” used herein specify the presence of stated elements, but do not preclude the presence or addition of other elements, unless otherwise defined.

It will be understood that when a component such as a film, a region, a layer, etc., is referred to as being “on”, “connected to”, “coupled to”, or “adjacent to” another component, it can be directly on, connected, coupled, or adjacent to the other component, or intervening components may be present. It will also be understood that when a component is referred to as being “between” two components, it can be the only component between the two components, or one or more intervening components may also be present. It will also be understood that when a component is referred to as “covering” another component, it can be the only component covering the other component, or one or more intervening components may also be covering the other component. Other words used to describe the relationships between components should be interpreted in a like fashion.

In the specification, the expression such as “A and/or B” may include A, B, or A and B. The expression such as “at least one of A and B” may include A, B, or A and B.

In the following embodiments, when X and Y are connected to each other, it may include a case in which X and Y are electrically connected, a case in which X and Y are functionally connected, and a case in which X and Y are directly connected. Here, X and Y may be objects, for example, apparatuses, devices, circuits, wirings, electrodes, terminals, conductive films, layers, etc. Accordingly, a certain connection relationship, for example, is not limited to the connection relationship described in the drawings or detailed descriptions, and may include things other than the connection relationship described in the drawings or detailed descriptions.

A case in which X and Y are electrically connected to each other may include, for example, a case in which one or more elements, for example, switches, transistors, capacitors, inductors, resistors, diodes, etc., which enable the electric connection between X and Y, is connected between X and Y.

In the following embodiments, the term “on” used in connection with a device state may refer to an activated state of the device, and the term “off” may refer to a deactivated state of the device. The term “on” used in connection with a signal received by a device may refer to a signal that activates the device, and the term “off” may refer to a signal that deactivates the device. A device may be activated by a high-level voltage or a low-level voltage. For example, a P-channel transistor is activated by a low-level voltage, and an N-channel transistor is activated by a high-level voltage. Accordingly, it should be understood that the “on” voltages for a P-channel transistor and an N-channel transistor are at opposite (low vs. high) voltage levels. Hereinafter, a voltage that turns on a transistor is referred to as an on-voltage, and a voltage that turns off a transistor is referred to as an off-voltage. A period during which an on-voltage of a signal is maintained is referred to as an on-voltage period, and a period during which an off-voltage is maintained is referred to as an off-voltage period.

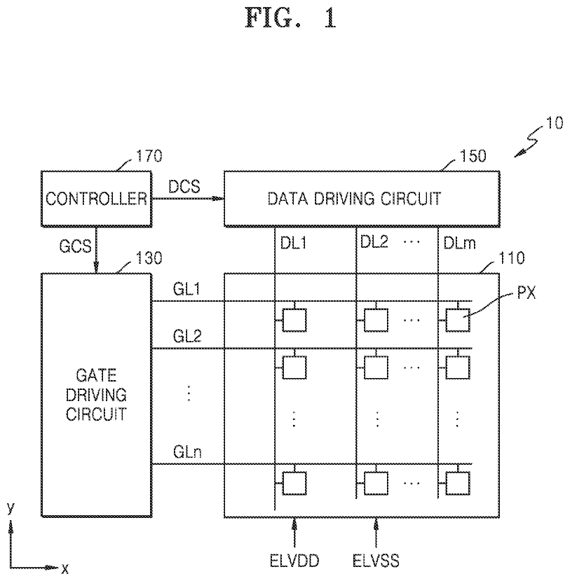

FIG. 1 is a schematic diagram illustrating a display apparatus 10 according to an embodiment.

The display apparatus 10 according to an embodiment may be a display apparatus, such as, for example, an organic light-emitting display apparatus, an inorganic light-emitting display apparatus (e.g., an inorganic electroluminescent (EL) display apparatus), and a quantum-dot light-emitting display apparatus.

Referring to FIG. 1, the display apparatus 10 according to an embodiment may include a pixel unit 110 (also referred to as a display panel), a gate driving circuit 130, a data driving circuit 150, and a controller 170.

A plurality of pixels PX and a plurality of signal lines through which electrical signals are input to the pixels PX may be arranged in the pixel unit 110.

The pixels PX may be repeatedly arranged in a first direction (x direction or row direction) and a second direction (y direction or column direction). The pixels PX may be arranged in various forms, such as, for example, a stripe array, a pentile array, a diamond array, a mosaic array, and the like, and may display an image. Each of the pixels PX may include an organic light-emitting diode as a display element, and a pixel circuit connected to the organic light-emitting diode. The pixel circuit may include a plurality of transistors and at least one capacitor.

In an embodiment, a plurality of transistors included in the pixel unit 110 may be N-type oxide thin film transistors. For example, an oxide thin film transistor may be a low temperature polycrystalline oxide (LTPO) thin film transistor. However, this is only an example, and the N-type transistor is not limited thereto. For example, according to embodiments, an active pattern (semiconductor layer) included in the transistors may include an inorganic material semiconductor (e.g., amorphous silicon, polysilicon), an organic material semiconductor, or the like.

The signal lines through which electrical signals are input to the pixels PX may include a plurality of gate lines GL1 to GLn extending in the first direction and a plurality of data lines DL1 to DLm extending in the second direction, where n and m are positive integers. The gate lines GL1 to GLn may be spaced apart from each other in the second direction, and gate signals may be transmitted to the pixels PX through the gate lines GL1 to GLn. The data lines DL1 to DLm may be spaced apart from each other in the first direction, and data signals may be transmitted to the pixels PX through the data lines DL1 to DLm. Each of the pixels PX may be connected to at least one gate line corresponding thereto among the gate lines GL1 to GLn and a data line corresponding thereto among the data lines DL1 to DLm.

The gate driving circuit 130 may be connected to the gate lines GL1 to GLn, may generate gate signals in response to a gate driving control signal GCS received from the controller 170, and may sequentially provide the generated gate signals respectively to the gate lines GL1 to GLn. The gate lines GL1 to GLn may be connected to gates of transistors included in each of the pixels PX. A gate signal may be a gate control signal that controls turning on and turning off of a transistor connected to the gate line. The gate signal may be a square wave signal including an on-voltage that turns the transistor on and an off-voltage that turns the transistor off. In an embodiment, the on-voltage may be a high-level voltage, and the off-voltage may be a low-level voltage.

When a period during which the on-voltage of a signal is maintained is an on-time and a period during which the off-voltage of a signal is maintained is an off-time, the on-time and the off-time of a gate signal may be determined according to the function of a transistor that receives a gate signal in each of the pixels PX. The gate driving circuit 130 may include a shift register that sequentially generates and outputs gate signals.

The data driving circuit 150 may be connected to the data lines DL1 to DLm, and may provide data signals to the data lines DL1 to DLm in response to a data driving control signal DCS received from the controller 170. The data signals provided to the data lines DL1 to DLm may be provided to the pixels PX that have received gate signals.

When the display apparatus 1 is an organic light-emitting display apparatus, a first power voltage ELVDD and a second power voltage ELVSS may be provided to the pixels PX of the pixel unit 110. The first power voltage ELVDD may be a high-level voltage provided to a first electrode (pixel electrode or anode) of an organic light-emitting diode included in each of the pixels PX. The second power voltage ELVSS may be a low-level voltage provided to a second electrode (counter electrode or cathode) of the organic light-emitting diode. The first power voltage ELVDD and the second power voltage ELVSS may be driving voltages that cause the pixels PX to emit light.

The controller 170 may generate the gate driving control signal GCS and the data driving control signal DCS, based on externally input signals. The controller 170 may provide the gate driving control signal GCS to the gate driving circuit 130, and the data driving control signal DCS to the data driving circuit 150.

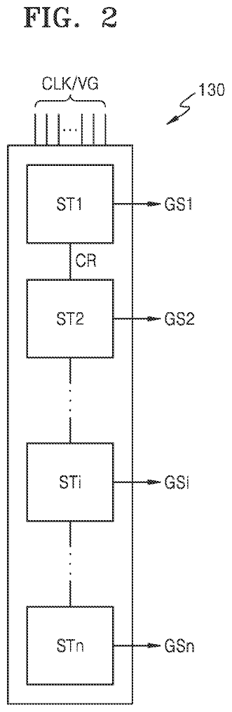

FIG. 2 is a schematic diagram illustrating a gate driving circuit according to an embodiment.

Referring to FIG. 2, the gate driving circuit 130 may include a plurality of stages ST1 to STn. The stages ST1 to STn may sequentially output gate signals GS1 to GSn to the gate lines GL1 to GLn.

Each of the stages ST1 to STn may be connected to the gate line of a corresponding row. Each of the stages ST1 to STn may receive at least one clock signal CLK and at least one voltage signal VG, generate a corresponding gate signal GS1, GS2, . . . GSn, and provide the generated gate signal GS1, GS2, . . . GSn to the gate line GL connected thereto. For example, an i-th stage STi may provide an i-th gate signal GSi to the gate line GL of the i-th row. In other words, each of the stages ST1 to STn may provide the corresponding gate signal GS1, GS2, . . . GSn to the gate line GL of a corresponding row.

Each of the stages ST1 to STn may receive the at least one clock signal CLK and the at least one voltage signal VG, and provide a carry signal CR to the preceding or subsequent stage. The preceding stage may be a stage before at least one stage, and the subsequent stage may be a stage after at least one stage.

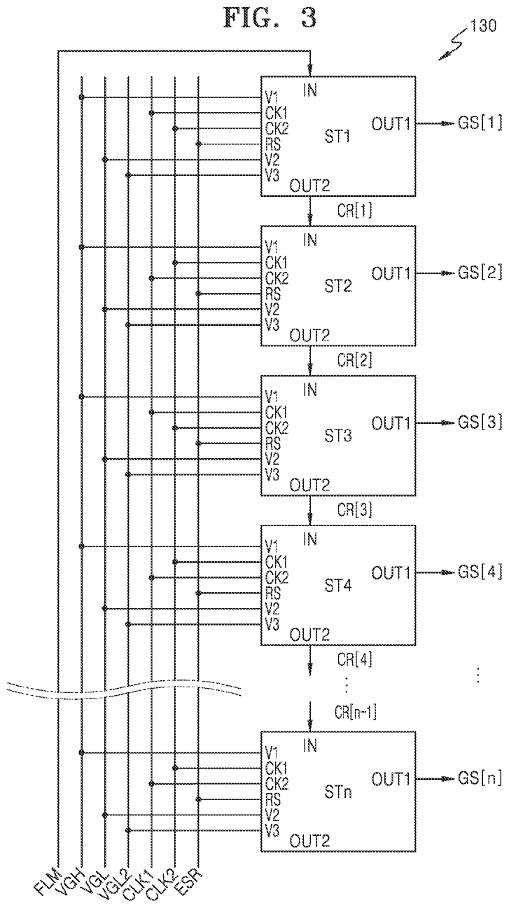

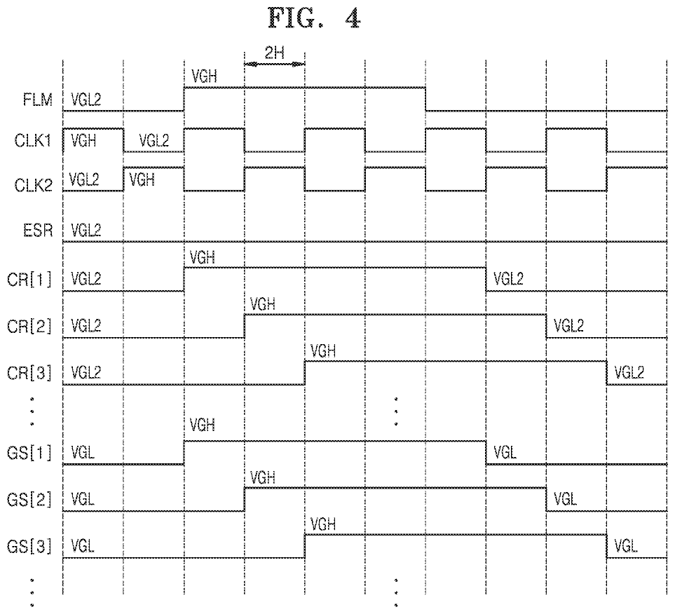

FIG. 3 is a schematic diagram illustrating the gate driving circuit 130 according to an embodiment. FIG. 4 is a timing diagram of input/output signals of the gate driving circuit 130 of FIG. 3 according to an embodiment.

Referring to FIG. 3, the gate driving circuit 130 may include the stages ST1 to STn. The number of stages provided in the gate driving circuit 130 may be variously changed according to the number of rows provided in the pixel unit 110.

The stages ST1 to STn may respectively output, in response to a start signal, gate signals GS[1], GS[2], GS[3], GS[4], . . . , and GS[n]. For example, an n-th stage STn may output the n-th gate signal GS[n] to an n-th gate line. An external signal FLM, which is a start signal that controls the timing of the first gate signal GS[1], may be provided to the first stage ST1. Hereinafter, the on-voltage may denote a high-level voltage, and the off-voltage may denote a low-level voltage.

Each of the stages ST1 to STn may include an input terminal IN, a first clock terminal CK1, a second clock terminal CK2, a first voltage input terminal V1, a second voltage input terminal V2, a third voltage input terminal V3, a reset terminal RS, a first output terminal OUT1, and a second output terminal OUT2.

The start signal may be input (provided) to the input terminal IN. The start signal may be the external signal FLM or a previous carry signal. In an embodiment, the external signal FLM may be input to the input terminal IN of the first stage ST1, and a carry signal output from the preceding stage, e.g. the previous carry signal may be input to the input terminal IN of each of the 2^{nd} to n-th stages ST2 to STn other than the first stage ST1. For example, an (n−1)th carry signal CR[n−1] output from an (n−1)th stage STn−1 may be input to the input terminal IN of the n-th stage STn.

A first clock signal CLK1 or a second clock signal CLK2 may be input to the first clock terminal CK1 and the second clock terminal CK2. The first clock signal CLK1 and the second clock signal CLK2 may be alternately input to the first clock terminals CK1 of the stages ST1 to STn. The second clock signal CLK2 and the first clock signal CLK1 may be alternately input to the second clock terminals CK2 of the stages ST1 to STn. For example, the first clock signal CLK1 and the second clock signal CLK2 may be respectively input to the first clock terminal CK1 and the second clock terminal CK2 of the odd-numbered stages (ST1, ST3, . . . ). The second clock signal CLK2 and the first clock signal CLK1 may be respectively input to the first clock terminal CK1 and the second clock terminal CK2 of the even-numbered stages (ST2, ST4, . . . ).

As illustrated in FIG. 4, the first clock signal CLK1 and the second clock signal CLK2 may be square wave signals repeating a first voltage VGH of a high level and a third voltage VGL2 of a low level. The cycles of the first clock signal CLK1 and the second clock signal CLK2 may be 4 horizontal periods 4H including one-time high level and one-time low level. The first clock signal CLK1 and the second clock signal CLK2 may be signals having the same waveform and shifted phases. For example, the second clock signal CLK2 may have the same waveform as the first clock signal CLK1 and may be input with a phase shifted (phase delayed) at certain intervals. According to embodiments, the second clock signal CLK2 is shifted by a half cycle from the first clock signal CLK1, and the on-time of the second clock signal CLK2 does not overlap the on-time of the first clock signal CLK1. The on-times of the first clock signal CLK1 and the second clock signal CLK2 may be less than about 2H or may be about 2H.

A reset signal ESR may be input to the reset terminal RS. The reset signal ESR is input as an on-voltage of the first voltage VGH at a certain timing, and as an off-voltage of the third voltage VGL2 at the other timing. For example, when power is input to the display apparatus (power on), the reset signal ESR is input to the stages ST1 to STn for a certain time as the first voltage VGH, and after the certain time passes, the reset signal ESR may be input to the stages ST1 to STn as a second voltage VGL or the third voltage VGL2. While the stages ST1 to STn operate to generate the gate signals GS[1], GS[2], GS[3], GS[4], . . . , and GS[n], the reset signal ESR may be input as the second voltage VGL or the third voltage VGL2. FIG. 4 shows an example in which the reset signal ESR of the third voltage VGL2 is input during the operation of the stages ST1 to STn.

The first voltage VGH may be input to the first voltage input terminal V1, the second voltage VGL may be input to the second voltage input terminal V2, and the third voltage VGL2 may be input to the third voltage input terminal V3. The third voltage VGL2 may have a voltage level that is lower than the second voltage VGL. The first voltage VGH, the second voltage VGL, and the third voltage VGL2, as global signals, may be input from, for example, the controller 170 illustrated in FIG. 1, a power supply unit, and/or the like.

The gate signals GS[1], GS[2], GS[3], GS[4], . . . , and GS[n] may be output from the first output terminals OUT1. The gate signals GS[1], GS[2], GS[3], GS[4], . . . , and GS[n] output from the first output terminals OUT1 of the stages ST1 to STn may be shifted by 2H. Each gate signal may be provided to a pixel through a corresponding output line, for example, a gate line. The on-time of the gate signals GS[1], GS[2], GS[3], GS[4], . . . , and GS[n] may be different from the on-time of the external signal FLM as a start signal. For example, the on-time of the external signal FLM may be 8H, and the on-time of the gate signals GS[1], GS[2], GS[3], GS[4], . . . , and GS[n] may be 10H.

The carry signal CR may be output from the second output terminal OUT2. The carry signals CR[1], CR[2], CR[3], CR[4], . . . , and CR[n] output from the second output terminals OUT2 of the stages ST1 to STn may be shifted by 2H. Each carry signal may be input to the input terminal IN of the subsequent stage. The on-time of the carry signals CR[1], CR[2], CR[3], CR[4], . . . , and CR[n] may be different from the on-time of the external signal FLM. For example, the on-time of the external signal FLM may be 8H, and the on-time of the carry signals CR[1], CR[2], CR[3], CR[4], . . . , and CR[n] may be 10H. The on-time of the carry signal CR and the on-time of the gate signal GS respectively output from each of the stages ST1 to STn may be the same. The on-time of the carry signal CR and the on-time of the gate signal GS respectively output from each of the stages ST1 to STn may overlap each other.

The timing (rising time) when the on-time of the external signal FLM input to the first stage ST1 starts and the rising time of the gate signal GS[1] and the carry signal CR[1] output from the first stage ST1 may be the same. The rising time of the previous carry signal input to each of the 2^{nd} to n-th stages ST2 to STn and the rising time of the gate signal and the carry signal output from each of the 2^{nd} to n-th stages ST2 to STn may be different from each other. The rising time of the gate signal and the carry signal output from each of the 2^{nd} to n-th stages ST2 to STn may be delayed by a certain time, for example, a half cycle of a clock signal, from the rising time of the previous carry signal input to each of the 2^{nd} to n-th stages ST2 to STn. For example, the rising time of the gate signal GS[2] and the carry signal CR[2], which are output from the second stage ST2, may be shifted by 2H from the rising time of the previous carry signal CR[1].

According to embodiments, at least one dummy stage may be further provided in the rear end of the n-th stage STn that is the final stage among the stages ST1 to STn. The carry signal CR output from the second output terminal OUT2 of the n-th stage may be input to the input terminal of the dummy stage. According to embodiments, the dummy stage is not connected to the gate line of the pixel unit 110 of FIG. 1. According to an embodiment, the dummy stage may be connected to a dummy gate line, the dummy gate line may be connected to a dummy pixel that does not display an image, and the dummy stage is not used for displaying an image. According to an embodiment, the dummy pixel may be omitted, and only a dummy gate line may be provided around the pixel unit 110.

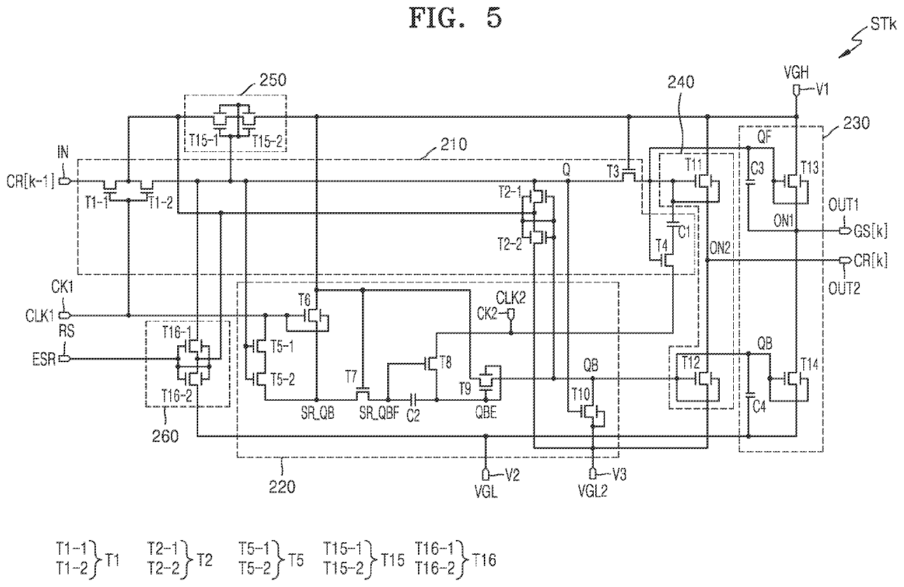

FIG. 5 is a circuit diagram of an example of a stage STk constituting the gate driving circuit 130 of FIG. 3

Each of the stages ST1 to STn has a plurality of nodes, and hereinafter, some of the nodes may be referred to as first and second output nodes ON1 and ON2, and first, second, and third nodes Q, QF, and QB.

The stage STk of FIG. 5, where k is a positive integer, is a stage corresponding to a k-th row of the pixel unit 110, and may receive a (k−1)th carry signal CR[k−1] from the preceding stage, output a k-th gate signal GS[k] to a gate line of a k-th row, and output a k-th carry signal CR[k] to the subsequent stage. When k is 1, that is, in a case of the first stage ST1, the external signal FLM may be input, as a start signal, to the input terminal IN.

In odd-numbered stages, the first clock terminal CK1 may receive the first clock signal CLK1, and the second clock terminal CK2 may receive the second clock signal CLK2. In even-numbered stages, the first clock terminal CK1 may receive the second clock signal CLK2, and the second clock terminal CK2 may receive the first clock signal CLK1. For convenience of explanation, a case in which the stage STk is an odd-numbered stage in which the previous carry signal is received in the input terminal IN is described below as an example.

In an embodiment, the voltage level of an on-voltage (on-voltage level) is a high level, and the voltage level of an off-voltage (off-voltage level) is a low level.

The stage STk may include a first node controller 210 (also referred to as a first node controller circuit), a second node controller 220 (also referred to as a second node controller circuit), a first output unit 230 (also referred to as a first output circuit), a second output unit 240 (also referred to as a second output circuit), a leakage control unit 250 (also referred to as a leakage control circuit), and a reset unit 260 (also referred to as a reset circuit). Each of the first node controller 210, the second node controller 220, the first output unit 230, the second output unit 240, the leakage control unit 250, and the reset unit 260 may include at least one transistor.

The at least one transistor may be an N-type transistor. The at least one transistor may be an N-type oxide semiconductor transistor. Some of the at least one transistor may each be a single gate transistor including one gate. Some of the at least one transistor may each be a dual gate transistor including a pair of a first gate and a second gate. In an embodiment, the pair of a first gate and a second gate may be respectively arranged on different layers with a semiconductor disposed therebetween. For example, the first gate may be a top gate arranged on top of a semiconductor, and the second gate may be a bottom gate arranged at the bottom of a semiconductor. In an embodiment, the pair of a first gate and a second gate may receive the same signal. In an embodiment, the pair of a first gate and a second gate may receive different signals.

A previous carry signal CR[k−1] that is a start signal may be input to the input terminal IN, the first clock signal CLK1 may be input to the first clock terminal CK1, the second clock signal CLK2 may be input to the second clock terminal CK2, the first voltage VGH may be input to the first voltage input terminal V1, the second voltage VGL may be input to the second voltage input terminal V2, the third voltage VGL2 may be input to the third voltage input terminal V3, and the reset signal ESR may be input to the reset terminal RS.

The first node controller 210 may be connected between the input terminal IN and the second node QF. The first node controller 210 may control a voltage level of the first node Q and a voltage level of the second node QB, based on the previous carry signal CR[k−1] and the third voltage VGL2. The first node controller 210 may include a first transistor T1, a second transistor T2, a third transistor T3, and a fourth transistor T4. The first node controller 210 may further include a first capacitor C1. The first transistor T1, the third transistor T3, and the fourth transistor T4 may each be a single gate transistor. The second transistor T2 may be a dual gate transistor.

The first transistor T1 may include a plurality of sub-transistors connected in series between the input terminal IN and the first node Q. The sub-transistors may include a pair of a first-first transistor T1-1 and a first-second transistor T1-2. The first-first transistor T1-1 and the first-second transistor T1-2 may each include a gate connected to the first clock terminal CK1. The first transistor T1 may be turned on when the first clock signal CLK1 is a high-level voltage, and may control the voltage level of the first node Q according to the voltage of the previous carry signal CR[k−1].

The second transistor T2 may include a plurality of sub-transistors connected in series between the first node Q and the third voltage input terminal V3. The sub-transistors may include a pair of a second-first transistor T2-1 and a second-second transistor T2-2. The second-first transistor T2-1 and the second-second transistor T2-2 may each include a first gate and a second gate which are connected to a third node QB. The second transistor T2 may be turned on when the voltage of the third node QB is a high-level voltage, and may control the voltage of the first node Q to the voltage level of the third voltage VGL2 input to the third voltage input terminal V3.

The third transistor T3 may be connected between the first node Q and the second node QF. The third transistor T3 may include a gate connected to the first voltage input terminal V1. The third transistor T3 may control the voltage level of the second node QF to the voltage level of the first node Q by making the first node Q and the second node QF electrically connected to each other. The third transistor T3 may always be turned on in response to the first voltage VGH input to the first voltage input terminal V1, and may prevent a line voltage drop and the like between the first node Q and the second node QF. Accordingly, the on-voltage of the k-th gate signal GS[k] may be stably output.

The fourth transistor T4 may be connected between the second clock terminal CK2 and the first capacitor C1. The fourth transistor T4 may include a gate connected to the second node QF. The fourth transistor T4 may be turned on when the voltage of the second node QF is a high-level voltage, and may transmit the second clock signal CLK2 input to the second clock terminal CK2 to one end of the first capacitor C1.

The first capacitor C1 may be connected between the second node QF and the fourth transistor T4. The voltage of the second node QF may be boosted to a voltage, e.g., twice the VGH, greater than the first voltage VGH, by the first capacitor C1 and the fourth transistor T4 turned on when the second clock signal CLK2 is a high-level voltage.

The second node controller 220 may be connected between the first node Q and the third node QB. The second node controller 220 may control the voltage of the third node QB by inverting the voltage level of the first node Q. The second node controller 220 may control the voltage of the third node QB based on the first voltage VGH and the third voltage VGL2.

The second node controller 220 may include a second-first node controller that controls the third node QB to be a low-level voltage when the voltage of the first node Q is a high-level voltage, and a second-second node controller that controls the voltage of the third node QB to be a high-level voltage when the voltage of the first node Q is a low-level voltage. The second-first node controller may include a tenth transistor T10. The second-second node controller may include a fifth transistor T5, a sixth transistor T6, a seventh transistor T7, an eighth transistor T8, a ninth transistor T9, and a second capacitor C2. The fifth transistor T5, the seventh transistor T7, and the eighth transistor T8 may each be a single gate transistor. The sixth transistor T6, the ninth transistor T9, and the tenth transistor T10 may each be a dual gate transistor.

The fifth transistor T5 may include a plurality of sub-transistors connected in series between the first clock terminal CK1 and a fourth node SR_QB. The sub-transistors may include a pair of a fifth-first transistor T5-1 and a fifth-second transistor T5-2. The fifth-first transistor T5-1 and the fifth-second transistor T5-2 may each include the gate connected to the first node Q. The fifth transistor T5 may be turned on when the voltage of the first node Q is a high-level voltage, and may transmit the first clock signal CLK1 input to the first clock terminal CK1 to the fourth node SR_QB.

The sixth transistor T6 may be connected between the first voltage input terminal V1 and the fourth node SR_QB. The sixth transistor T6 may include a first gate and a second gate which are connected to the first clock terminal CK1. The sixth transistor T6 may be turned on when the first clock signal CLK1 is a high-level voltage, and may transmit the first voltage VGH input to the first voltage input terminal V1 to the fourth node SR_QB.

The seventh transistor T7 may be connected between the fourth node SR_QB and a fifth node SR_QBF. The seventh transistor T7 may include a gate connected to the first voltage input terminal V1. The seventh transistor T7 may always be turned on in response to the first voltage VGH to cause the fourth node SR_QB and the fifth node SR_QBF to be electrically conducted to each other, thereby controlling the voltage level of the fifth node SR_QBF to be the voltage level of the fourth node SR_QB.

The eighth transistor T8 may be connected between the second clock terminal CK2 and a sixth node QBE. The eighth transistor T8 may include a gate connected to the fifth node SR_QBF. The eighth transistor T8 may be turned on when the voltage of the fifth node SR_QBF is a high-level voltage, and may transmit the second clock signal CLK2 input to the second clock terminal CK2 to the sixth node QBE.

The ninth transistor T9 may be connected between the first voltage input terminal V1 and the third node QB. The ninth transistor T9 may include a first gate and a second gate which are connected to the sixth node QBE. The ninth transistor T9 may be turned on when the voltage of the sixth node QBE is a high-level voltage, and may control the voltage level of the third node QB to be the first voltage VGH input to the first voltage input terminal V1.

The tenth transistor T10 may be connected between the third node QB and the third voltage input terminal V3. The tenth transistor T10 may include a first gate connected to the first node Q and a second gate connected to the third voltage input terminal V3. The tenth transistor T10 may be turned on when the first node Q is a high-level voltage, and may control the voltage level of the third node QB to be the third voltage VGL2 input to the third voltage input terminal V3.

The second capacitor C2 may be connected between the fifth node SR_QBF and the sixth node QBE. By way of the second capacitor C2 and the eighth transistor T8 which is turned on when the second clock signal CLK2 is a high-level voltage, the voltage of the fifth node SR_QBF may be boosted to a voltage, e.g., twice the VGH, greater than the first voltage VGH.

The first output unit 230 may output a gate signal of an on-voltage level or a gate signal of an off-voltage level depending on the voltage levels of the second node QF and the third node QB. The first output unit 230 may transmit the first voltage VGH or the second voltage VGL to the first output terminal OUT1 connected to a first output node ON1 depending on the voltage levels of the second node QF and the third node QB. A high-level voltage of the first voltage VGH or a low-level voltage of the second voltage VGL from the first output terminal OUT1 may be output as the k-th gate signal GS[k]. The first output unit 230 may include a thirteenth transistor T13 and a fourteenth transistor T14. The first output unit 230 may further include a third capacitor C3 and a fourth capacitor C4. The thirteenth transistor T13 and the fourteenth transistor T14 may each be a dual gate transistor.

The thirteenth transistor T13 may be connected between the first voltage input terminal V1 and the first output node ON1. The thirteenth transistor T13 may include a first gate and a second gate which are connected to the second node QF. The thirteenth transistor T13 may be turned on or off according to the voltage level of the second node QF. The thirteenth transistor T13 may be a pull-up transistor that outputs a high-level voltage. The thirteenth transistor T13 may be turned on when the voltage of the second node QF is a high-level voltage, and may transmit the first voltage VGH from the first voltage input terminal V1 to the first output node ON1.

The fourteenth transistor T14 may be connected between the first output node ON1 and the second voltage input terminal V2. The fourteenth transistor T14 may include a first gate and a second gate which are connected to the third node QB. The fourteenth transistor T14 may be turned on or off depending on the voltage level of the third node QB. The fourteenth transistor T14 may be a pull-down transistor that outputs a low-level voltage. The fourteenth transistor T14 may be turned on when the voltage of the third node QB is a high-level voltage, and may transmit the second voltage VGL from the second voltage input terminal V2 to the first output node ON1.

The third capacitor C3 may be connected between the second node QF and the first output node ON1. The voltage of the second node QF may be boosted by the third capacitor C3. The fourth capacitor C4 may be connected between the third node QB and the first output node ON1. The voltage of the third node QB may be boosted by the fourth capacitor C4.

The second output unit 240 may output a carry signal of an on-voltage level or a carry signal of an off-voltage level depending on the voltage levels of the second node QF and the third node QB. The second output unit 240 may transmit the first voltage VGH or the third voltage VGL2 to the second output terminal OUT2 connected to a second output node ON2, depending on the voltage levels of the second node QF and the third node QB. A high-level voltage of the first voltage VGH or a low-level voltage of the third voltage VGL2 from the second output terminal OUT2 may be output as the k-th carry signal CR[k]. The second output unit 240 may include an eleventh transistor T11 and a twelfth transistor T12. The eleventh transistor T11 and the twelfth transistor T12 may be a dual gate transistor.

The eleventh transistor T11 may be connected between the first voltage input terminal V1 and the second output node ON2. The eleventh transistor T11 may include a first gate and a second gate which are connected to the second node QF. The eleventh transistor T11 may be turned on or off according to the voltage level of the second node QF. The eleventh transistor T11 may be a pull-up transistor that outputs a high-level voltage. The eleventh transistor T11 may be turned on when the voltage of the second node QF is a high-level voltage, and may transmit the first voltage VGH from the first voltage input terminal V1 to the second output node ON2.

The twelfth transistor T12 may be connected between the second output node ON2 and the third voltage input terminal V3. The twelfth transistor T12 may include a first gate and a second gate which are connected to the third node QB. The twelfth transistor T12 may be turned on or off depending on the voltage level of the third node QB. The twelfth transistor T12 may be a pull-down transistor that outputs a low-level voltage. The twelfth transistor T12 may be turned on when the voltage of the third node QB is a high-level voltage, and may transmit the third voltage VGL2 from the third voltage input terminal V3 to the second output node ON2.

The leakage control unit 250 may block a leakage current from the transistors (e.g., the first transistor T1, the second transistor T2, and a sixteenth transistor T16) connected to the first node Q, when the voltage of the first node Q is a high-level voltage. The leakage control unit 250 may include a fifteenth transistor T15 (also referred to as a leakage prevention transistor), and the fifteenth transistor T15 may include a plurality of sub-transistors that are connected in series with each other. The sub-transistors may include a pair of a fifteenth-first transistor T15-1 and a fifteenth-second transistor T15-2. The fifteenth-first transistor T15-1 and the fifteenth-second transistor T15-2 may each be a dual gate transistor including a first gate and a second gate which are connected to the first node Q.

One end (e.g., a first end) of the fifteenth transistor T15 may be connected to the first voltage input terminal V1. The other end (e.g., a second end) of the fifteenth transistor T15 may be connected to an intermediate node (common electrode) between the first-first transistor T1-1 and the first-second transistor T1-2, an intermediate node (common electrode) between the second-first transistor T2-1 and the second-second transistor T2-2, and an intermediate node (common electrode) between a sixteenth-first transistor T16-1 and a sixteenth-second transistor T16-2. The fifteenth transistor T15 may be turned on when the voltage of the first node Q is a high-level voltage, and may reduce the current leakage of the first node Q by maintaining the intermediate nodes of the first transistor T1, the second transistor T2 and the sixteenth transistor T16 at high-level voltages.

The reset unit 260 may reset the first node Q based on the reset signal ESR provided to the reset terminal RS. The reset unit 260 may include the sixteenth transistor T16 (reset transistor), and the sixteenth transistor T16 may include a plurality of sub-transistors connected in series with each other between the first node Q and the second voltage input terminal V2. The sub-transistors may include a pair of the sixteenth-first transistor T16-1 and the sixteenth-second transistor T16-2. The sixteenth-first transistor T16-1 and the sixteenth-second transistor T16-2 may each be a dual gate transistor including a first gate and a second gate which are connected to the reset terminal RS. The sixteenth transistor T16 may be turned on when the reset signal ESR is input at a high-level voltage, and may reset (initialize) the first node Q to the third voltage VGL2. As the reset signal ESR of the third voltage VGL2 is provided during the operation of the gate driving circuit 130, the sixteenth transistor T16 may be turned off.

When an oxide semiconductor transistor is a dual gate transistor including a pair of gates, while the size of a transistor (e.g., a channel width to a channel length (W/L)) is reduced, an external light blocking effect by a bottom gate may be obtained. In contrast, the dual gate transistor exhibits a large change in threshold voltage, compared with a single gate transistor.

A stage according to an embodiment includes a plurality of N-type transistors including an oxide semiconductor, and some (e.g., at least one of the first transistor T1, the third transistor T3, the fourth transistor T4, the fifth transistor T5, the seventh transistor T7, and the eighth transistor T8) transistors having a long on-bias time (high-level voltage input time) among the N-type transistors are provided as single gate transistors, and thus, a change in threshold voltage of a transistor due to repeated driving may be reduced.

Furthermore, the stage according to an embodiment includes some transistors having a long high-level voltage input time among the N-type transistors as dual gate transistors, and a voltage level of a voltage input to a bottom gate may be different from a voltage level of a voltage input to a top gate. For example, the tenth transistor T10 may reduce a change in threshold voltage of a transistor due to repeated driving in which a high-level voltage is input to a top gate of the tenth transistor T10, by allowing a low-level voltage is input to the bottom gate thereof.

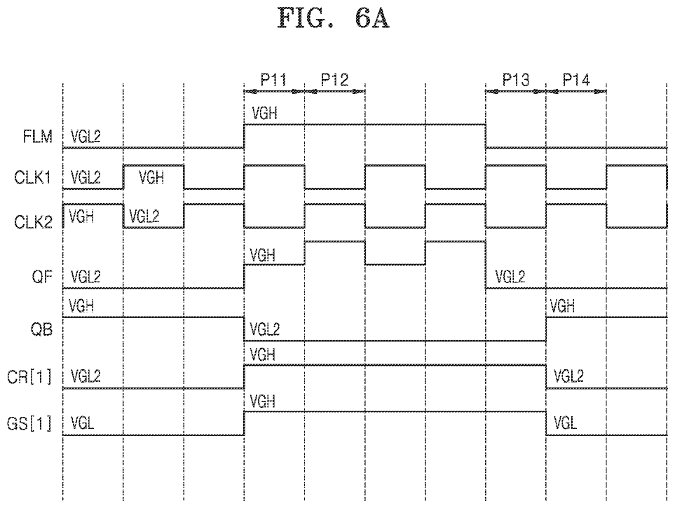

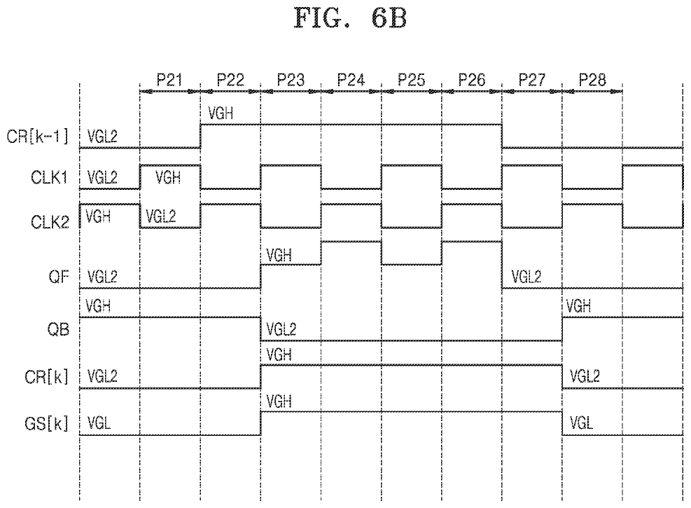

FIGS. 6A and 6B are timing diagrams showing an example of an operation of the stage illustrated in FIG. 5. FIG. 6A is a timing diagram of input/output signals when the stage illustrated in FIG. 5 is a first stage. FIG. 6B is a timing diagram of input/output signals when the stage illustrated in FIG. 5 is an odd-numbered stage among the second and later stages. In FIGS. 6A and 6B, the width of each of periods (P11 to P14 and P21 to P28) may be 2H. In the following description, for convenience of explanation, the voltage level of the first voltage VGH is represented as a high level, and the voltage levels of the second voltage VGL and the third voltage VGL2 are represented as low levels. A high-level voltage and a low-level voltage may be defined as an on-voltage and an off-voltage, respectively.

FIG. 6A shows the external signal FLM as a start signal, a first clock signal CLK1 input to the first clock terminal CK1, the second clock signal CLK2 input to the second clock terminal CK2, the node voltages of the second and third nodes QF and QB, and the carry signal CR[1] and the gate signal GS[1] which are output signals. The operation of the first stage ST1 is described below.

In the first period P11, the external signal FLM may be a high-level voltage, the first clock signal CLK1 may be a high-level voltage, and the second clock signal CLK2 may be a low-level voltage.

The first transistor T1 may be turned on in response to the first clock signal CLK1 of a high-level voltage, and the external signal FLM may be transmitted to the first node Q by the first transistor T1 which is turned on, so that the voltage of the first node Q may become a high-level voltage. By way of the third transistor T3 which is turned on, the first node Q and the second node QF are connected to each other (e.g., electrically connected to each other), and the voltage of the second node QF may become a high-level voltage. Accordingly, the thirteenth transistor T13 and the eleventh transistor T11 having gates connected to the second node QF may be turned on, and the gate signal GS[1] and the carry signal CR[1] which are high-level voltages may be output from the first output terminal OUT1 and the second output terminal OUT2, respectively.

As the voltages of the first node Q and the second node QF are high-level voltages, the fifth transistor T5 and the tenth transistor T10 having gates connected to the first node Q may be turned on. The third voltage VGL2 may be transmitted to the third node QB by the tenth transistor T10 which is turned on, so that the voltage of the third node QB may become a low-level voltage.

The sixth transistor T6 may be turned on in response to the first clock signal CLK1, and the first voltage VGH may be transmitted to the fourth node SR_QB by the sixth transistor T6 and the fifth transistor T5 which are turned on, so that the voltage of the fourth node SR_QB may become a high-level voltage. The voltage of the fifth node SR_QBF may become a high-level voltage by way of the seventh transistor T7 that is turned on in response to the first voltage VGH. As the voltage of the fifth node SR_QBF is a high-level voltage, the eighth transistor T8 may be turned on, and the second clock signal CLK2 of a low-level voltage is transmitted to the sixth node QBE so that the voltage of the sixth node QBE may become a low-level voltage.

In the second period P12, the external signal FLM may be a high-level voltage, the first clock signal CLK1 may be a low-level voltage, and the second clock signal CLK2 may be a high-level voltage.

The first transistor T1 is turned off in response to the first clock signal CLK1 so that the first node Q and the second node QF become a floating state, and the second node QF may maintain a high-level state by the first capacitor C1 and the third capacitor C3 which are boost capacitors. In this state, the second node QF may maintain a higher-level voltage in the first period P11 by way of the first capacitor C1 and the third capacitor C3. Accordingly, the thirteenth transistor T13 and the eleventh transistor T11 may maintain a turn-on state, and the gate signal GS[1] and the carry signal CR[1] which are high-level voltages may be output. The voltage of the third node QB may be maintained at a low-level voltage by the tenth transistor T10 which is turned on.

The sixth transistor T6 is turned off in response to the first clock signal CLK1, and the first clock signal CLK1 of a low level may be transmitted to the fourth node SR_QB by the fifth transistor T5 which is turned on, so that the voltage of the fourth node SR_QB may become a low-level voltage. Accordingly, the voltage of the fifth node SR_QBF may become a low-level voltage by the seventh transistor T7 which is turned on, so that the eighth transistor T8 is turned off, and the voltage of the sixth node QBE may be maintained at a low-level voltage.

While the external signal FLM maintains a high-level voltage, the first clock signal CLK1 and the second clock signal CLK2 are alternately applied as a high-level voltage and a low-level voltage, and as the first period P11 and the second period P12 are repeated as described above, the gate signal GS[1] and the carry signal CR[1] which are high-level voltages may be output from the first output terminal OUT1 and the second output terminal OUT2, respectively.

In the third period P13, the external signal FLM may be shifted to a low-level voltage, the first clock signal CLK1 may be a high-level voltage, and the second clock signal CLK2 may be a low-level voltage.

The first transistor T1 and the sixth transistor T6 may be turned on in response to the first clock signal CLK1. The voltages of the first node Q and the second node QF may become low-level voltages by way of the first transistor T1 and the third transistor T3 which are turned on, and the fifth transistor T5 and the tenth transistor T10 may be turned off. As the second node QF is in a low-level state, the thirteenth transistor T13 and the eleventh transistor T11 may be turned off. The voltages of the fourth node SR_QB and the fifth node SR_QBF may become high-level voltages by the sixth transistor T6 and the seventh transistor T7 which are turned on. As the fifth node SR_QBF is in a high-level state, the eighth transistor T8 may be turned on, and the second clock signal CLK2 may be transmitted to the sixth node QBE so that the sixth node QBE may be in a low-level state. As the ninth transistor T9 is turned off, the third node QB may be in a floating state and may maintain a low-level state.

The first output node ON1 and the second output node ON2 may each maintain a high-level state as in the second period P12, and the gate signal GS[1] and the carry signal CR[1] which are high-level voltages may be output from the first output terminal OUT1 and the second output terminal OUT2, respectively.

In the fourth period P14, the external signal FLM may be a low-level voltage, the first clock signal CLK1 may be a low-level voltage, and the second clock signal CLK2 may be a high-level voltage.

The first transistor T1 may be turned off in response to the first clock signal CLK1, the first node Q and the second node QF may maintain a low-level state, and the thirteenth transistor T13 and the eleventh transistor T11 may be turned off. The sixth transistor T6 may be turned off in response to the first clock signal CLK1, and as the first node Q is in a low-level state, the fifth transistor T5 may be turned off and the fourth node SR_QB may maintain a high-level state.

Accordingly, the fifth node SR_QBF may be in a high-level state by way of the seventh transistor T7 which is turned on, and thus, the eighth transistor T8 may be turned on and the voltage of the sixth node QBE may become a high-level voltage by the second clock signal CLK2. In this state, due to the second capacitor C2, the fifth node SR_QBF may maintain a high-level voltage higher than that in the third period P13.

The ninth transistor T9 may be turned on, and the voltage of the third node QB may become a high-level voltage by the first voltage VGH. Accordingly, the fourteenth transistor T14 which is turned on may transmit the second voltage VGL of a low level to the first output node ON1, and the gate signal GS[1] of a low-level voltage may be output from the first output terminal OUT1. The twelfth transistor T12 which is turned on may transmit the third voltage VGL2 of a low level to the second output node ON2, and the carry signal CR[1] of a low-level voltage may be output from the second output terminal OUT2.

FIG. 6B shows the previous carry signal CR[k−1] as a start signal, the first clock signal CLK1 input to the first clock terminal CK1, the second clock signal CLK2 input to the second clock terminal CK2, the node voltages of the second and third nodes QF and QB, and the k-th carry signal CR[k] and the k-th gate signal GS[k] which are output signals. The operation of the odd-numbered stage STk after the first stage ST1 is described below.

In the first period P21, the previous carry signal CR[k−1] may be a low-level voltage, the first clock signal CLK1 may be a high-level voltage, and the second clock signal CLK2 may be a low-level voltage.

The first transistor T1 may be turned on in response to the first clock signal CLK1 of a high-level voltage. The previous carry signal CR[k−1] may be transmitted to the first node Q by the first transistor T1 which is turned on, so that the voltage of the first node Q may become a low-level voltage. The voltage of the second node QF may maintain a low-level voltage that is a previous voltage level by way of the third transistor T3 which is turned on. Accordingly, the fifth transistor T5 and the tenth transistor T10 having gates connected to the first node Q may maintain a turn-off state, and the fourth transistor T4, the eleventh transistor T11, and the thirteenth transistor T13 having gates connected to the second node QF may maintain a turn-off state.

The sixth transistor T6 may be turned on in response to the first clock signal CLK1 of a high-level voltage, and the first voltage VGH is transmitted to the fourth node SR_QB so that the voltage of the fourth node SR_QB may become a high-level voltage. The voltage of the fifth node SR_QBF may become a high-level voltage by way of the seventh transistor T7 that is turned on in response to the first voltage VGH. As the voltage of the fifth node SR_QBF is a high-level voltage, the eighth transistor T8 may be turned on, and the second clock signal CLK2 of a low-level voltage is transmitted to the sixth node QBE so that the voltage of the sixth node QBE may become a low-level voltage. The ninth transistor T9 is turned off, the third node QB may be in a floating state and the voltage of the third node QB may maintain a high-level voltage that is a previous voltage level.

Accordingly, the fourteenth transistor T14 may transmit the second voltage VGL of a low level to the first output node ON1, and the k-th gate signal GS[k] of a low-level voltage may be continuously output from the first output terminal OUT1. The twelfth transistor T12 may transmit the third voltage VGL2 of a low level to the second output node ON2, and the k-th carry signal CR[k] of a low-level voltage may be continuously output from the second output terminal OUT2.

In the second period P22, the previous carry signal CR[k−1] may be shifted to a high-level voltage, the first clock signal CLK1 may be a low-level voltage, and the second clock signal CLK2 may be a high-level voltage.

The first transistor T1 may be turned off in response to the first clock signal CLK1 of a low-level voltage, the first node Q and the second node QF may be in a floating state, and the voltages of the first node Q and the second node QF may maintain low-level voltages.

The sixth transistor T6 may be turned off in response to the first clock signal CLK1, and as the fifth transistor T5 may be turned off, the voltages of the fourth node SR_QB and the fifth node SR_QBF may be maintained at a high-level voltage. The second clock signal CLK2 of a high-level voltage is transmitted to the sixth node QBE by the eighth transistor T8 which is turned on, and thus, the voltage of the sixth node QBE may become a high-level voltage. In this state, due to the second capacitor C2, the fifth node SR_QBF may have a high-level voltage higher than that in the first period P21.

As the ninth transistor T9 having a gate connected to the sixth node QBE is turned on, the first voltage VGH may be transmitted to the third node QB, and the voltage of the third node QB may become a high-level voltage. Accordingly, the fourteenth transistor T14 which is turned on may transmit the second voltage VGL of a low level to the first output node ON1, and the k-th gate signal GS[k] of a low-level voltage may be continuously output from the first output terminal OUT1. The twelfth transistor T12 which is turned on may transmit the third voltage VGL2 of a low level to the second output node ON2, and the k-th carry signal CR[k] of a low-level voltage may be continuously output from the second output terminal OUT2.

In the third period P23, the previous carry signal CR[k−1] may be a high-level voltage, the first clock signal CLK1 may be a high-level voltage, and the second clock signal CLK2 may be a low-level voltage.

The first transistor T1 may be turned on in response to the first clock signal CLK1 of a high-level voltage, the previous carry signal CR[k−1] may be transmitted to the first node Q by the first transistor T1 which is turned on, and the voltage of the first node Q may become a high-level voltage. The first node Q and the second node QF may be connected to each other (e.g., electrically connected to each other) by the third transistor T3 which is turned on, and the voltage of the second node QF may become a high-level voltage. Accordingly, the thirteenth transistor T13 and the eleventh transistor T11 having gates connected to the second node QF may be turned on, and the k-th gate signal GS[k] and the k-th carry signal CR[k] of high-level voltages may be output from the first output terminal OUT1 and the second output terminal OUT2, respectively.

As the voltages of the first node Q and the second node QF are high-level voltages, the fifth transistor T5 and the tenth transistor T10 having gates connected to the first node Q may be turned on. The third voltage VGL2 may be transmitted to the third node QB by the tenth transistor T10 which is turned on, so that the voltage of the third node QB may become a low-level voltage. Accordingly, the fourteenth transistor T14 and the twelfth transistor T12 may be turned off.

The sixth transistor T6 may be turned on in response to the first clock signal CLK1, and the first voltage VGH may be transmitted to the fourth node SR_QB by the sixth transistor T6 and the fifth transistor T5 which are turned on, so that the voltage of the fourth node SR_QB may become a high-level voltage. The voltage of the fifth node SR_QBF may become a high-level voltage by the seventh transistor T7 that is turned on in response to the first voltage VGH. As the voltage of the fifth node SR_QBF is a high-level voltage, the eighth transistor T8 may be turned on, and the second clock signal CLK2 of a low-level voltage may be transmitted to the sixth node QBE so that the voltage of the sixth node QBE may become a low-level voltage.

In the fourth period P24, the previous carry signal CR[k−1] may be a high-level voltage, the first clock signal CLK1 may be a low-level voltage, and the second clock signal CLK2 may be a high-level voltage.

The first transistor T1 may be turned off in response to the first clock signal CLK1 so that the first node Q and the second node QF become a floating state, and the second node QF may maintain a high-level state by the first capacitor C1 and the third capacitor C3, which are boost capacitors. In this state, due to the first capacitor C1 and the third capacitor C3, the second node QF may maintain a high-level voltage higher than that in the third period P23. Accordingly, the thirteenth transistor T13 and the eleventh transistor T11 may maintain a turn-on state, and the k-th gate signal GS[k] and the k-th carry signal CR[k] of high-level voltages may be output. The voltage of the third node QB may be maintained at a low-level voltage by the tenth transistor T10 which is turned on.

The sixth transistor T6 may be turned off in response to the first clock signal CLK1, and the first clock signal CLK1 of a low level may be transmitted to the fourth node SR_QB by the fifth transistor T5 which is turned on, so that the voltage of the fourth node SR_QB may become a low-level voltage. Accordingly, the voltage of the fifth node SR_QBF may become a low-level voltage by the seventh transistor T7 which is turned on, so that the eighth transistor T8 is turned off, and the voltage of the sixth node QBE may be maintained at a low-level voltage.

In the fifth period P25, the operation of the stage STk may be substantially the same as the operation of the stage STk in the third period P23, and the operation of the stage STk in the sixth period P26 may be substantially the same as the operation of the stage STk in the fourth period P24. Accordingly, for convenience of explanation, redundant descriptions thereof are omitted.

In the seventh period P27, the previous carry signal CR[k−1] may be shifted to a low-level voltage, the first clock signal CLK1 may be a high-level voltage, and the second clock signal CLK2 may be a low-level voltage.

The first transistor T1 may be turned on in response to the first clock signal CLK1. As the previous carry signal CR[k−1] is transmitted to the first node Q by the first transistor T1 which is turned on, the voltage of the first node Q may become a low-level voltage, and the voltage of the second node QF may become a low-level voltage by the third transistor T3 which is turned on. As the voltage of the first node Q is a low-level voltage, the fifth transistor T5 and the tenth transistor T10 may be turned off. As the voltage of the second node QF is a low-level voltage, the thirteenth transistor T13 and the eleventh transistor T11 may be turned off.

The sixth transistor T6 may be turned on in response to the first clock signal CLK1. The first voltage VGH is transmitted to the fourth node SR_QB by the sixth transistor T6 that is turned on, the voltage of the fourth node SR_QB may become a high-level voltage, and the voltage of the fifth node SR_QBF may become a high-level voltage by the seventh transistor T7 which is turned on. As the voltage of the fifth node SR_QBF is a high-level voltage, the eighth transistor T8 may be turned on, and the second clock signal CLK2 may be transmitted to the sixth node QBE so that the voltage of the sixth node QBE may become a low-level voltage. The ninth transistor T9 is turned off, the third node QB may be in a floating state, and the voltage of the third node QB may be maintained at a low-level voltage.

The voltages of the first output node ON1 and the second output node ON2 may each maintain a high-level voltage as in the sixth period P26, and the k-th gate signal GS[k] and the k-th carry signal CR[k] of high-level voltages may be output from the first output terminal OUT1 and the second output terminal OUT2, respectively.

In the eighth period P28, the previous carry signal CR[k−1] may be a low-level voltage, the first clock signal CLK1 may be a low-level voltage, and the second clock signal CLK2 may be a high-level voltage.

The first transistor T1 may be turned off in response to the first clock signal CLK1, the voltages of the first node Q and the second node QF may maintain low-level voltages, and the thirteenth transistor T13 and the eleventh transistor T11 may be turned off.

The sixth transistor T6 may be turned off in response to first clock signal CLK1, the fifth transistor T5 having a gate connected to the first node Q may be turned off, and the voltage of the fourth node SR_QB may maintain a high-level voltage. Accordingly, the voltage of the fifth node SR_QBF may become a high-level voltage by the seventh transistor T7 which is turned on. Accordingly, the eighth transistor T8 may be turned on, and the sixth node QBE may have a high-level voltage by the second clock signal CLK2. In this state, due to the second capacitor C2, the voltage of the fifth node SR_QBF may maintain a high-level voltage higher than in the seventh period P27. The ninth transistor T9 having a gate connected to the sixth node QBE may be turned on, and the voltage of the third node QB may become a high-level voltage by the first voltage VGH. Accordingly, the fourteenth transistor T14 may be turned on, and the second voltage VGL of a low level may be transmitted to the first output node ON1 so that the k-th gate signal GS[k] of a low-level voltage may be output from the first output terminal OUT1. The twelfth transistor T12 may be turned on, and the third voltage VGL2 of a low level may be transmitted to the second output node ON2 so that the k-th carry signal CR[k] of a low-level voltage may be output from the second output terminal OUT2.

The even-numbered stages are different from the odd-numbered stages in that the second clock signal CLK2 is input to the first clock terminal CK1 and the first clock signal CLK1 is input to the second clock terminal CK2, and the other circuit configurations and operations thereof are the same as those of the odd-numbered stages described above with reference to FIG. 5.

The odd-numbered stages and the even-numbered stages may each output the gate signals and the carry signals which are high levels, in synchronization with the rising time of a clock signal input to the first clock terminal CK1.

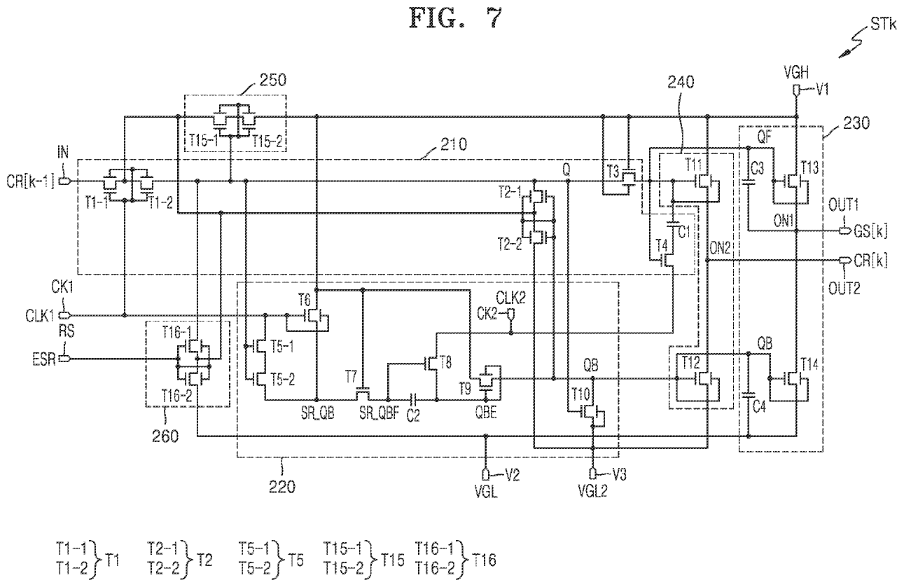

FIGS. 7 to 9 are circuit diagrams showing various modified examples of a stage circuit according to an embodiment.

The stage illustrated in FIG. 7 is different from the stage illustrated in FIG. 5 in that the first transistor T1 and the third transistor T3 are dual gate transistors. In the stage illustrated in FIG. 7, the first transistor T1 may include the first-first transistor T1-1 and the first-second transistor T1-2, and the first-first transistor T1-1 and the first-second transistor T1-2 may each be a dual gate transistor having a first gate and a second gate which are connected to the first clock terminal CK1. The third transistor T3 may be a dual gate transistor having a first gate and a second gate which are connected to the first voltage input terminal V1. The other configurations and operations illustrated in the stage illustrated in FIG. 7 may be the same as those of the stage illustrated in FIG. 5.

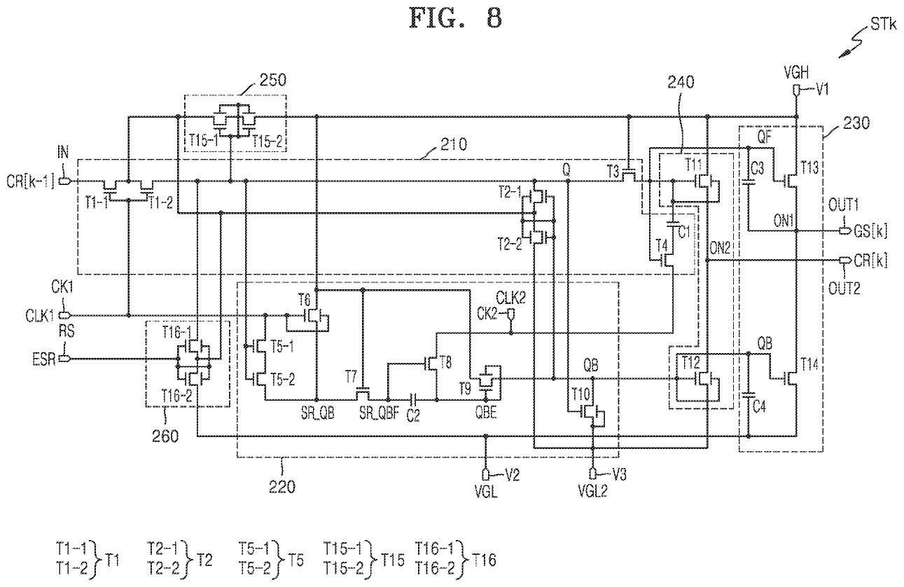

The stage illustrated in FIG. 8 is different from the stage illustrated in FIG. 5 in that the thirteenth transistor T13 and the fourteenth transistor T14 are single gate transistors. In the stage illustrated in FIG. 8, the thirteenth transistor T13 may be a single gate transistor having the gate connected to the second node QF, and the fourteenth transistor T14 may be a single gate transistor having a gate connected to the third node QB. The other configurations and operations of the stage illustrated in FIG. 8 are the same as those of the stage illustrated in FIG. 5.

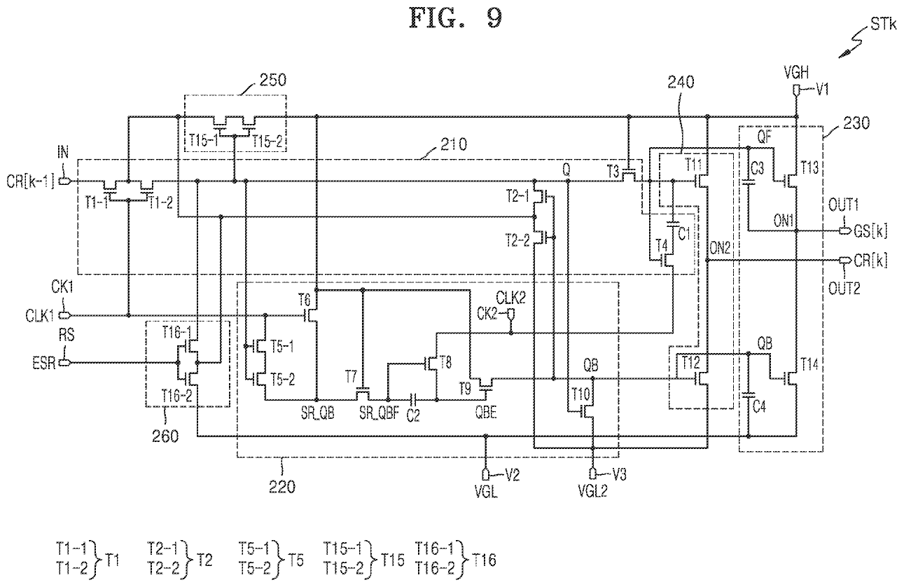

The stage illustrated in FIG. 9 is different from the stage illustrated in FIG. 5 in that the first to sixteenth transistors T1 to T16 are all single gate transistors. The operation of the stage illustrated in FIG. 9 is the same as that of the stage illustrated in FIG. 5.

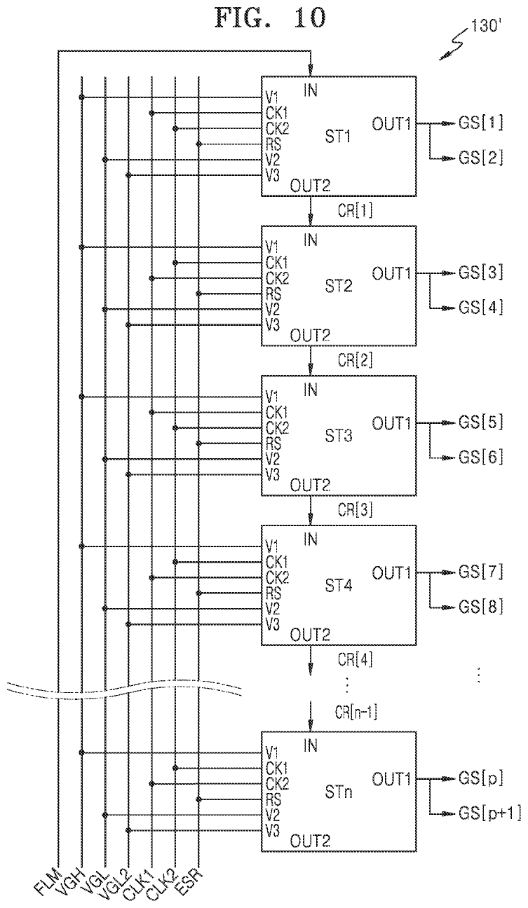

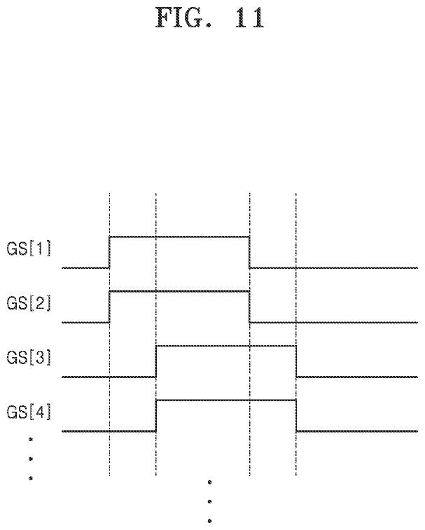

FIG. 10 is a schematic diagram illustrating a gate driving circuit 130′ according to an embodiment. FIG. 11 is a schematic timing diagram of gate signals output by the gate driving circuit 130′ of FIG. 10 according to an embodiment.

The gate driving circuit 130′ illustrated in FIG. 10 may include the stages ST1 to STn, and may be different from the gate driving circuit 130 illustrated in FIG. 3 in that each of the stages ST1 to STn outputs a pair of gate signals. The circuit configuration of each of the stages ST1 to STn may be the same as that of the stage illustrated in FIG. 5, and a gate signal output from the first output terminal OUT1 of each stage may be simultaneously provided to two rows of the pixel unit 110. For example, as illustrated in FIG. 11, a pair of the first gate signal GS[1] and second the gate signal GS[2] output from the first output terminal OUT1 of the first stage ST1 may be simultaneously provided to a gate line in a first row and a gate line in a second row of the pixel unit 110.

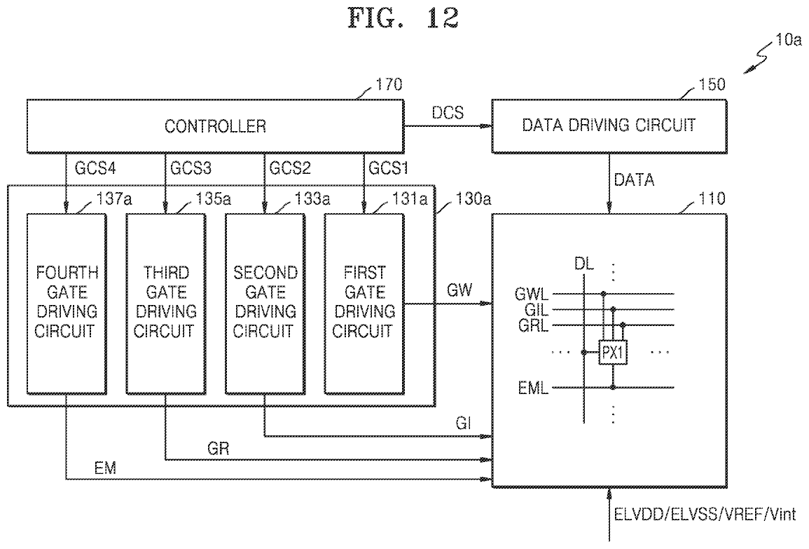

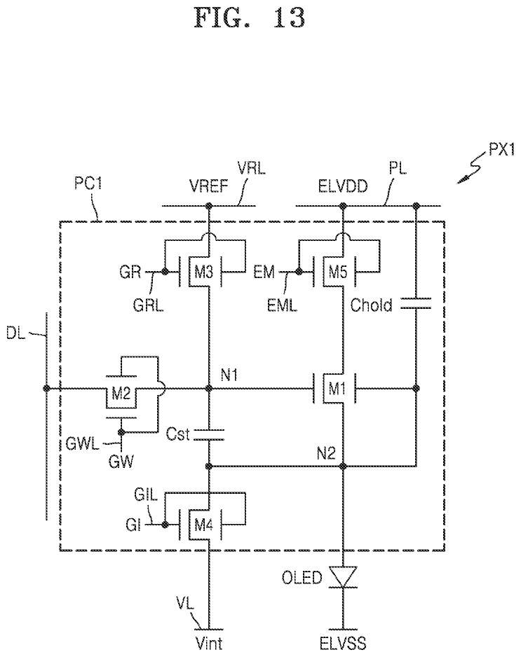

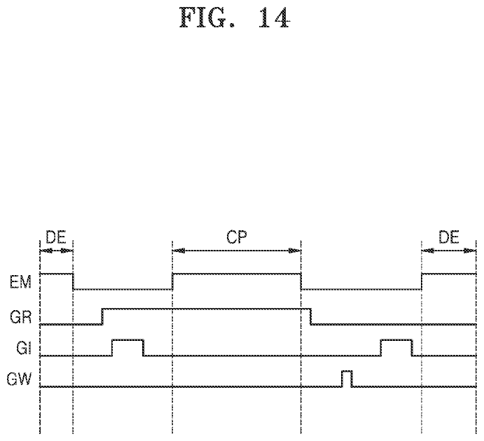

FIG. 12 is a schematic block diagram of a display apparatus 10a according to an embodiment. FIG. 13 is a circuit diagram of a pixel PX1 of FIG. 12 according to an embodiment. FIG. 14 is a schematic timing diagram of gate signals output by a gate driving circuit 130a of FIG. 12 to the pixel PX1 of FIG. 12 according to an embodiment.

Although FIG. 1 illustrates that each of the pixels PX is connected to one gate line, and that the gate driving circuit 130 outputs a gate signal to one gate line, this is an example, and each of the pixels PX may be connected to one or more gate lines, and at least one gate driving circuit may output at least one gate signal to one or more gate lines, according to embodiments.

As illustrated in FIG. 12, the display apparatus 10a according to an embodiment may include the pixel unit 110, the gate driving circuit 130a, the data driving circuit 150, and the controller 170. The gate driving circuit 130a may include a first gate driving circuit 131a, a second gate driving circuit 133a, a third gate driving circuit 135a, and a fourth gate driving circuit 137a.

The first gate driving circuit 131a may be connected to a plurality of first gate lines GWL, and may sequentially provide a first gate signal GW to the first gate lines GWL in response to a first gate driving control signal GCS1. The second gate driving circuit 133a may be connected to a plurality of second gate lines GIL, and may sequentially provide a second gate signal GI to the second gate lines GIL in response to a second gate driving control signal GCS2. The third gate driving circuit 135a may be connected to a plurality of third gate lines GRL, and may sequentially provide a third gate signal GR to the third gate lines GRL in response to a third gate driving control signal GCS3. The fourth gate driving circuit 137a may be connected to a plurality of fourth gate lines EML, and may sequentially provide a fourth gate signal EM to the fourth gate line EML in response to a fourth gate driving control signal GCS4.

As illustrated in FIG. 13, the pixel PX1 may be connected to a first gate line GWL that transmits the first gate signal GW, a second gate line GIL that transmits the second gate signal GI, a third gate line GRL that transmits the third gate signal GR, a fourth gate line EML that transmits the fourth gate signal EM, and a data line DL that transmits a data signal DATA. Furthermore, the pixel PX1 may be connected to a driving voltage line PL that provides a first driving voltage ELVDD, an initialization voltage line VL that provides an initialization voltage Vint, and a reference voltage line VRL that provides a reference voltage VREF.

The pixel PX1 may include an organic light-emitting diode OLED as a display element, and a pixel circuit PC1 connected to the organic light-emitting diode OLED. The pixel circuit PC1 may include first to fifth transistors M1 to M5 and first and second capacitors Cst and Chold. The first transistor M1 may be a driving transistor, and the second to fifth transistors M2 to M5 may be switching transistors. The first to fifth transistors M1 to M5 may be N-type oxide semiconductor transistors. The first to fifth transistors M1 to M5 may be dual gate transistors each having a first gate and a second gate. A node to which the gate of the first transistor M1 is connected may be defined as a first node N1, and a node to which the second terminal of the first transistor M1 is connected may be defined as a second node N2.

The first transistor M1 may include a first gate connected to the first node N1 and a second gate connected to the second node N2, and a first terminal connected to the fifth transistor M5 and a second terminal connected to the second node N2. The second gate of the first transistor M1 may be connected to the second terminal of the first transistor M1 and may receive a voltage applied to the second terminal of the first transistor M1, which may improve the output saturation characteristics of the first transistor M1. The first transistor M1 may receive a data signal according to the switching operation of the second transistor M2, and control an amount of a driving current flowing to the organic light-emitting diode OLED.

The second transistor M2 (data write transistor) may include a first gate and a second gate which are connected to the first gate line GWL, a first terminal connected to the data line DL, and a second terminal connected to the first node N1. The second transistor M2 may be turned on in response to the first gate signal GW transmitted through the first gate line GWL to electrically connect the data line DL with the first node N1, and may transmit a data signal transmitted through the data line DL to the first node N1.

The third transistor M3 (first initialization transistor) may include a first gate and a second gate which are connected to the third gate line GRL, a first terminal connected to the reference voltage line VRL, and a second terminal connected to the first node N1. The third transistor M3 may be turned on in response to the third gate signal GR transmitted through the third gate line GRL, and may transmit the reference voltage VREF transmitted through the reference voltage line VRL to the first node N1.

The fourth transistor M4 (second initialization transistor) may include a first gate and a second gate which are connected to the second gate line GIL, a first terminal connected to the second node N2, and a second terminal connected to the initialization voltage line VL. The fourth transistor M4 may be turned on in response to the second gate signal GI transmitted through the second gate line GIL, and may transmit the initialization voltage Vint transmitted through the initialization voltage line VL to the second node N2.

The fifth transistor M5 (emission control transistor) may include a first gate and a second gate which are connected to the fourth gate line EML, a first terminal connected to the driving voltage line PL, and a second terminal connected to the second terminal of the first transistor M1. The fifth transistor M5 may be turned on or off in response to the fourth gate signal EM transmitted through the fourth gate lines EML. When the fifth transistor M5 is turned on, the first transistor M1 outputs a driving current, and the organic light-emitting diode OLED starts emitting light, and thus, the fourth gate signal EM may be defined as an emission control signal.

A first capacitor Cst may be connected between the first node N1 and the second node N2. The first terminal of the first capacitor Cst may be connected to the first gate of the first transistor M1, and the second terminal of the first capacitor Cst may be connected to the second gate and the second terminal of the first transistor M1, the first terminal of the fourth transistor M4, and the pixel electrode of the organic light-emitting diode OLED.

The second capacitor Chold may be connected between the second node N2 and the driving voltage line PL. The first terminal of the second capacitor Chold may be connected to the driving voltage line PL, and the second terminal of the second capacitor Chold may be connected to the second gate and the second terminal of the first transistor M1, the second terminal of the first capacitor Cst, the first terminal of the fourth transistor M4, and the pixel electrode of the organic light-emitting diode OLED. The capacity of the first capacitor Cst may be greater than the capacity of the second capacitor Chold.

The organic light-emitting diode OLED may include the pixel electrode (anode) and the counter electrode (cathode) facing the pixel electrode, and the counter electrode may receive the second power voltage ELVSS. The counter electrode may be a common electrode that is common to the pixels PX.

Referring to FIG. 14, when the second gate signal GI of an on-voltage level is provided through the second gate line GIL, and the third gate signal GR of an on-voltage level is provided through the third gate line GRL, the fourth transistor M4 and the third transistor M3 may be turned on, the first gate of the first transistor M1 may be initialized to the reference voltage VREF, and the pixel electrode of the organic light-emitting diode OLED may be initialized to the initialization voltage Vint.

When the third gate signal GR of an on-voltage level is provided through the third gate line GRL, and the fourth gate signal EM of an on-voltage level is provided through the fourth gate lines EML (compensation period CP of FIG. 14), the third transistor M3 and the fifth transistor M5 may be turned on, and the first capacitor Cst is charged with a voltage corresponding to the threshold voltage of the first transistor M1 so that the threshold voltage of the first transistor M1 may be compensated for.

When the second transistor M2 is turned on as the first gate signal GW of an on-voltage level is provided through the first gate line GWL, the data signal through the data line DL may be transmitted to the first gate of the first transistor M1. Accordingly, the first capacitor Cst may be charged with the threshold voltage of the first transistor M1 and a voltage corresponding to the data signal.

When the fourth gate signal EM of an on-voltage level is provided through the fourth gate lines EML (emission period DE of FIG. 14), the second to fourth transistors M2, M3, and M4 may be turned off in response to the first gate signal GW, the second gate signal GI, and the third gate signal GR of an off-voltage level, the fifth transistor M5 may be turned on, and thus, the first transistor M1 may output a driving current and the organic light-emitting diode OLED may emit light with a luminance corresponding to the amount of the driving current.

After data write and before the emission period DE, the second gate signal GI of an on-voltage level may be provided through the second gate line GIL so that the pixel electrode of the organic light-emitting diode OLED may be initialized to the initialization voltage Vint.

The gate driving circuit 130 of FIG. 3 including the stages STk of FIG. 5 according to an embodiment may be applied to at least one of the first to fourth gate driving circuits 131a, 133a, 135a, and 137a illustrated in FIG. 12. For example, the gate driving circuit 130 of FIG. 3 may be applied to the fourth gate driving circuit 137a, and the gate signal GS that is an output signal of the gate driving circuit 130 may be the fourth gate signal EM that is output by the fourth gate driving circuit 137a through the fourth gate lines EML. The fourth gate signal EM may be provided to the compensation period CP and the emission period DE at a high-level voltage.

The fourth gate driving circuit 137a may generate and output, in response to the fourth gate driving control signal GCS4, the fourth gate signal EM of a high-level voltage having a certain on-time and a low-level voltage having a certain off-time, by the input signal and the clock signals as illustrated in FIGS. 6A and 6B, through the fourth gate lines EML, according to the timing illustrated in FIG. 14.

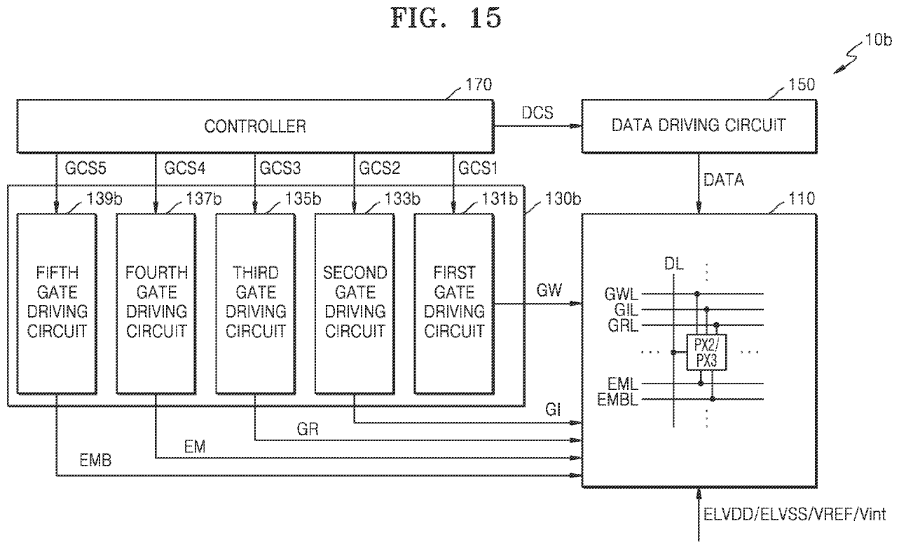

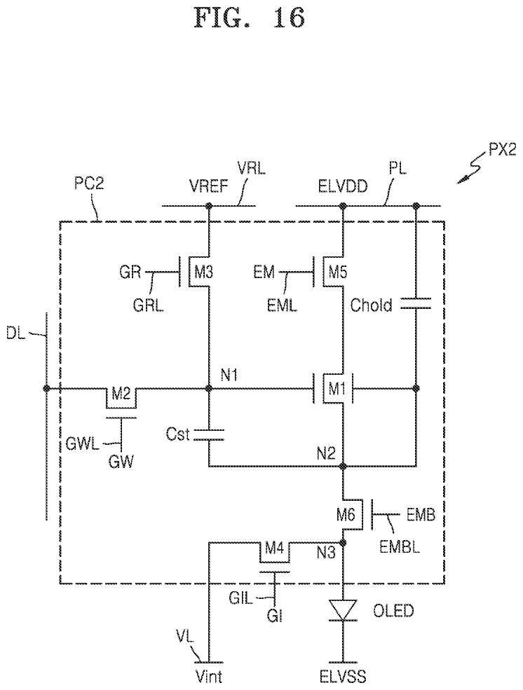

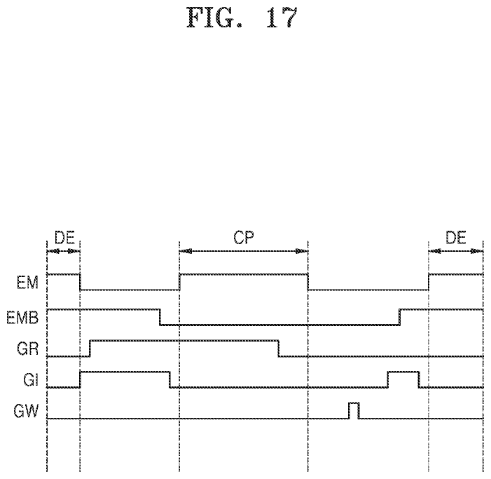

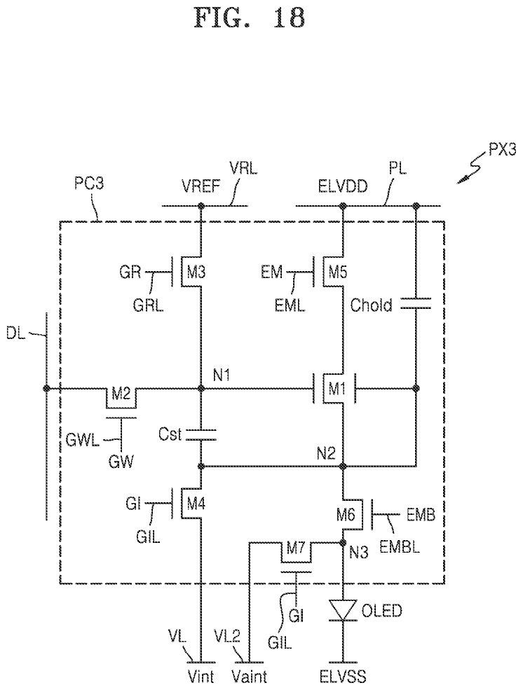

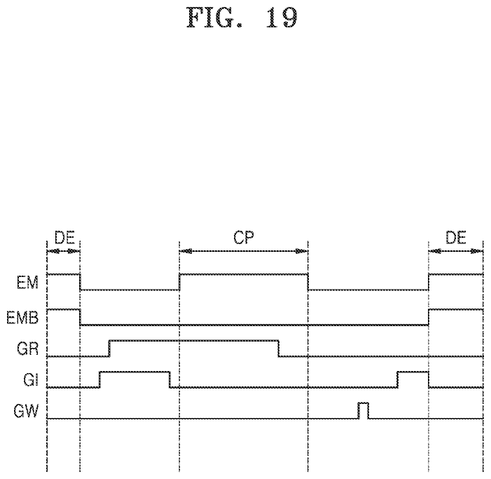

FIG. 15 is a schematic block diagram of a display apparatus 10b according to an embodiment. FIG. 16 is a circuit diagram showing an example of a pixel PX2 of FIG. 15. FIG. 17 is a schematic timing diagram of gate signals output by a gate driving circuit 130b of FIG. 15 to the pixel PX2 of FIG. 16 according to an embodiment. FIG. 18 is a circuit diagram showing an example of the pixel PX2 of FIG. 15. FIG. 19 is a schematic timing diagram of gate signals output by the gate driving circuit 130b of FIG. 15 to a pixel PX3 of FIG. 18 according to an embodiment. For convenience of explanation, the differences from embodiments described above are mainly described below, and a further description of components and technical aspects previously described may be omitted.

The display apparatus 10b illustrated in FIG. 15 may include the pixel unit 110, the gate driving circuit 130b, the data driving circuit 150, and the controller 170. The gate driving circuit 130b may include a first gate driving circuit 131b, a second gate driving circuit 133b, a third gate driving circuit 135b, a fourth gate driving circuit 137b, and a fifth gate driving circuit 139b.

The first gate driving circuit 131b may be connected to the first gate lines GWL, and may sequentially provide the first gate signal GW to the first gate lines GWL in response to the first gate driving control signal GCS1. The second gate driving circuit 133b may be connected to the second gate lines GIL, and may sequentially provide the second gate signal GI through the second gate lines GIL in response to the second gate driving control signal GCS2. The third gate driving circuit 135b may be connected to the third gate lines GRL, and may sequentially provide the third gate signal GR through the third gate lines GRL in response to the third gate driving control signal GCS3. The fourth gate driving circuit 137b may be connected to the fourth gate lines EML, and may sequentially provide the fourth gate signal EM through the fourth gate lines EML in response to the fourth gate driving control signal GCS4. The fifth gate driving circuit 139b may be connected to a plurality of fifth gate lines EMBL, and may sequentially provide a fifth gate signal EMB through the fifth gate lines EMBL in response to a fifth gate driving control signal GCS5.

A pixel circuit PC2 of the pixel PX2 illustrated in FIG. 16 is different from the pixel circuit PC1 of the pixel PX1 illustrated in FIG. 13 in that a sixth transistor M6 is added between the second node N2 and the pixel electrode of the organic light-emitting diode OLED, and that the first terminal of the fourth transistor M4 is connected to a third node N3 to which the sixth transistor M6 and the organic light-emitting diode OLED are connected.

The fourth transistor M4 may be a single gate transistor including a gate connected to the second gate line GIL, a first terminal connected to the third node N3, and a second terminal connected to the initialization voltage line VL.

The sixth transistor M6 (second emission control transistor) may be a single gate transistor including a gate connected to the fifth gate line EMBL, a first terminal connected to the second node N2, and a second terminal connected to the third node N3. The sixth transistor M6 may be turned on or off in response to the fifth gate signal EMB transmitted through the fifth gate line EMBL. When the fifth transistor M5 and the sixth transistor M6 are simultaneously turned on, the first transistor M1 may output a driving current, and the organic light-emitting diode OLED starts to emit light, and thus, the fourth gate signal EM and the fifth gate signal EMB may be defined as an emission control signal.

Referring to FIG. 17, the fifth gate signal EMB may be provided to the pixel PX2 in the compensation period CP at an off-voltage level, and in the emission period DE at an on-voltage level. Furthermore, the fifth gate signal EMB may be provided at an on-voltage level by partially overlapping the second gate signal GI of an on-voltage level.

As the sixth transistor M6 is turned off in the compensation period CP, the pixel PX2 illustrated in FIG. 16 may block the electrical connection between the first transistor M1 and the organic light-emitting diode OLED in the compensation period CP. Accordingly, as a compensation deviation due to a capacitor charge deviation of the organic light-emitting diode OLED is not generated in the compensation period CP, a luminance deviation may be reduced.

The gate driving circuit 130 of FIG. 3 including the stages STk of FIG. 5 according to an embodiment may be applied to at least one of the first to fifth gate driving circuits 131b, 133b, 135b, 137b, and 139b illustrated in FIG. 15. For example, the gate driving circuit 130 of FIG. 3 may be applied to the fourth gate driving circuit 137b and/or the fifth gate driving circuit 139b, and the gate signal GS that is an output signal of the gate driving circuit 130 may be the fourth gate signal EM output by the fourth gate driving circuit 137b through the fourth gate lines EML and/or the fifth gate signal EMB output by the fifth gate driving circuit 139b through the fifth gate line EMBL.

The fourth gate driving circuit 137b may generate and output, in response to the fourth gate driving control signal GCS4, the fourth gate signal EM of a high-level voltage having a certain on-time and a low-level voltage having a certain off-time, by the input signal and the clock signals as illustrated in FIGS. 6A and 6B, through the fourth gate lines EML, according to the timing illustrated in FIG. 17.

The fifth gate driving circuit 139b may generate and output, in response to the fifth gate driving control signal GCS5, the fifth gate signal EMB of a high-level voltage having a certain on-time and a low-level voltage having a certain off-time, by the input signal and the clock signals as illustrated in FIGS. 6A and 6B, through the fifth gate lines EMBL, according to the timing illustrated in FIG. 17.

A pixel circuit PC3 of a pixel PX3 illustrated in FIG. 18 is different from the pixel circuit PC1 of the pixel PX1 illustrated in FIG. 13 in that the sixth transistor M6 connected between the second node N2 and the pixel electrode of the organic light-emitting diode OLED, and a seventh transistor M7 connected between the third node N3 to which the sixth transistor M6 and the organic light-emitting diode OLED are connected and a second initialization voltage line VL2 are added.

The fourth transistor M4 may be a single gate transistor including the gate connected to the second gate line GIL, the first terminal connected to the second node N2, and the second terminal connected to the initialization voltage line VL.

The sixth transistor M6 may be a single gate transistor including the gate connected to the fifth gate line EMBL, the first terminal connected to the second node N2, and the second terminal connected to the third node N3. The sixth transistor M6 may be turned on or off in response to the fifth gate signal EMB transmitted through the fifth gate line EMBL. Referring to FIG. 19, the fifth gate signal EMB may be provided in the emission period DE at an on-voltage level.

The seventh transistor M7 may be a single gate transistor including the gate connected to the second gate line GIL, the first terminal connected to the third node N3, and a second terminal connected to the second initialization voltage line VL2. The seventh transistor M7 may be turned on in response to the second gate signal GI transmitted through the second gate line GIL and may transmit, to the third node N3, a second initialization voltage Vaint transmitted through the second initialization voltage line VL2. The second initialization voltage Vaint may be different from the initialization voltage Vint. The voltage level of the second initialization voltage Vaint may be greater than the voltage level of first the initialization voltage Vint.

The fourth gate driving circuit 137b may generate and output, in response to the fourth gate driving control signal GCS4, the fourth gate signal EM of a high-level voltage having a certain on-time and a low-level voltage having a certain off-time, by the input signal and the clock signals as illustrated in FIGS. 6A and 6B, through the fourth gate lines EML, according to a timing illustrated in FIG. 19.

The fifth gate driving circuit 139b may generate and output, in response to the fifth gate driving control signal GCS5, the fifth gate signal EMB of a high-level voltage having a certain on-time and a low-level voltage having a certain off-time, by the input signal and the clock signals as illustrated in FIGS. 6A and 6B, through the fifth gate lines EMBL, according to the timing illustrated in FIG. 19. In an embodiment, the first to sixth transistors of the pixel circuit PC2 of the pixel PX2 illustrated in FIG. 16 and the first to seventh transistors of the pixel circuit PC3 of a pixel PX3 illustrated in FIG. 18 are double gate transistors including a first gate and a second gate, as the pixel PX1 illustrated in FIG. 13.

The gate driving circuit according to an embodiment may include N-type oxide semiconductor transistors, and considering the characteristics degradation of a transistor according to bias stress, the blocking of external light, and the size of a transistor, some of the N-type oxide semiconductor transistors may be implemented as single gate transistors, and some of the N-type oxide semiconductor transistors may be implemented as dual gate transistors. A pair of gates of the dual gate transistor may receive the same signal or different signals.

The gate driving circuit according to an embodiment may output a high-level voltage or a low-level voltage as a gate signal at a timing determined according to pixel driving by adjusting the timing of a start signal and clock signals. The gate signal output by the gate driving circuit according to an embodiment may be an emission control signal input to the gate of a transistor (e.g., the fifth transistor M5 of FIG. 13, and the fifth transistor M5 and the sixth transistor M6 of FIGS. 16 and 18), which may control the light-emitting timing of a pixel.

As is traditional in the field of the present disclosure, embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, etc., which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions.

According to an embodiment, gate driving circuits that may stably output gate signals, and a display apparatuses including the gate driving circuits, are provided.

While the present disclosure has been particularly shown and described with reference to embodiments thereof, it will be understood by those of ordinary skill in the art that various changes in form and detail may be made therein without departing from the spirit and scope of the present disclosure as defined by the following claims.

What is claimed is:

1. A gate driving circuit comprising a plurality of stages, wherein each of the plurality of stages comprises:
a first node controller configured to control a voltage level of a first node and a voltage level of a second node;
a second node controller configured to control a voltage level of a third node; and
a first output unit connected between a first voltage input terminal to which a first voltage is input and a second voltage input terminal to which a second voltage is input, and configured to output the first voltage or the second voltage as a gate signal according to the voltage levels of the second node and the third node,
wherein the first node controller comprises:
a first transistor connected between an input terminal to which a start signal is input and the first node, and comprising a gate connected to a first clock terminal to which a first clock signal is input;
a second transistor connected between the first node and a third voltage input terminal to which a third voltage is input, and comprising a first gate and a second gate which are connected to the third node; and
a third transistor connected between the first node and the second node, and comprising a gate connected to the first voltage input terminal,
wherein the first gate and the second gate of the second transistor are disposed in different layers with a semiconductor disposed therebetween.

2. The gate driving circuit of claim 1, wherein a voltage level of the first voltage is greater than a voltage level of the second voltage, and
a voltage level of the third voltage is less than the voltage level of the second voltage.

3. The gate driving circuit of claim 1, wherein the first transistor comprises a plurality of sub-transistors connected in series with each other, and
a gate of each of the plurality of sub-transistors is connected to the first clock terminal.

4. The gate driving circuit of claim 1, wherein the second transistor comprises a plurality of sub-transistors connected in series with each other, and
a first gate and a second gate of each of the plurality of sub-transistors are connected to the third node.

5. The gate driving circuit of claim 1, wherein each of the first transistor and the second transistor comprises a pair of sub-transistors connected in series with each other, and
each of the plurality of stages further comprises a leakage prevention transistor comprising a gate connected to the first node, and comprising a first end connected to the first voltage input terminal and a second end connected to an intermediate node of the pair of sub-transistors.

6. The gate driving circuit of claim 1, wherein the first node controller comprises:
a fourth transistor connected between the second node and a second clock terminal to which a second clock signal is input, and comprising a gate connected to the second node; and
a first capacitor connected between the second node and the fourth transistor,
wherein the first clock signal and the second clock signal repeat a voltage of a first voltage level and a voltage of a second voltage level, and the second clock signal is shifted by a half cycle from the first clock signal.

7. The gate driving circuit of claim 1, wherein the second node controller comprises:
a fourth transistor connected between the third node and the third voltage input terminal, and comprising a first gate connected to the first node and a second gate connected to the third voltage input terminal.

8. The gate driving circuit of claim 7, wherein the second node controller further comprises:
a fifth transistor connected between the first clock terminal and a fourth node, and comprising a gate connected to the first node;
a sixth transistor connected between the first voltage input terminal and the fourth node, and comprising a first gate and a second gate which are connected to the first clock terminal;
a seventh transistor connected between the fourth node and a fifth node, and comprising a gate connected to the first voltage input terminal;
a capacitor connected between the fifth node and a sixth node;
an eighth transistor connected between a second clock terminal to which a second clock signal is input and the sixth node, and comprising a gate connected to the fifth node; and
a ninth transistor connected between the first voltage input terminal and the third node, and comprising a first gate and a second gate which are connected to the sixth node,
wherein the first clock signal and the second clock signal repeat a voltage of a first voltage level and a voltage of a second voltage level, and the second clock signal is shifted by a half cycle from the first clock signal.

9. The gate driving circuit of claim 1, wherein the first output unit comprises:
a first pull-up transistor connected between the first voltage input terminal and a first output node, and comprising a gate connected to the second node; and
a first pull-down transistor connected between the second voltage input terminal and the first output node, and comprising a gate connected to the third node.

10. The gate driving circuit of claim 1, wherein the first output unit comprises:
a first pull-up transistor connected between the first voltage input terminal and a first output node, and comprising a first gate and a second gate which are connected to the second node; and
a first pull-down transistor connected between the second voltage input terminal and the first output node, and comprising a first gate and a second gate which are connected to the third node,
wherein the first gate and the second gate of each of the first pull-up transistor and the first pull-down transistor are disposed in different layers with a semiconductor disposed therebetween.

11. The gate driving circuit of claim 1, wherein each of the plurality of stages further comprises:
a second output unit connected between the first voltage input terminal and the second voltage input terminal, and configured to output the first voltage or the second voltage as a carry signal according to the voltage levels of the second node and the third node.

12. The gate driving circuit of claim 11, wherein the second output unit comprises:
a pull-up transistor connected between the first voltage input terminal and an output node, and comprising a first gate and a second gate which are connected to the second node; and
a pull-down transistor connected between the second voltage input terminal and the output node, and comprising a first gate and a second gate which are connected to the third node,
wherein the first gate and the second gate of each of the pull-up transistor and the pull-down transistor are disposed in different layers with a semiconductor disposed therebetween.

13. The gate driving circuit of claim 11, wherein a start signal of a first stage among the plurality of stages is an external signal, and start signals of second and later stages among the plurality of stages are carry signals output from a preceding stage.

14. The gate driving circuit of claim 13, wherein on-times of the gate signal and the carry signals are greater than an on-time of the external signal.

15. The gate driving circuit of claim 13, wherein a timing when an on-time of the start signal of the first stage starts is the same as a timing when an on-time of a first gate signal output from the first stage starts, and
a timing when an on-time of a gate signal output from each of the second and later stages starts is delayed by a certain time from a timing when an on-time of a start signal of each of the second and later stages starts.

16. The gate driving circuit of claim 1, wherein each of the plurality of stages further comprises:
a reset transistor connected between the first node and the second voltage input terminal, and configured to reset the first node,
wherein the reset transistor comprises a first gate and a second gate which are connected to a reset terminal to which a reset signal is input.

17. A gate driving circuit comprising a plurality of stages, wherein each of the plurality of stages comprises:
a first node controller configured to control a voltage level of a first node and a voltage level of a second node;
a second node controller configured to control a voltage level of a third node; and
a first output unit connected between a first voltage input terminal to which a first voltage is input and a second voltage input terminal to which a second voltage is input, and configured to output the first voltage or the second voltage as a gate signal according to the voltage levels of the second node and the third node,
wherein the first node controller comprises:
a first transistor comprising a pair of first sub-transistors connected in series with each other between an input terminal to which a start signal is input and the first node, and comprising a gate of each of the first sub-transistors connected to a first clock terminal to which a first clock signal is input;
a second transistor comprising a pair of second sub-transistors connected in series with each other between the first node and a third voltage input terminal to which a third voltage is input, and comprising a gate of each of the second sub-transistors connected to the third node; and
a third transistor connected between the first node and the second node, and comprising a gate connected to the first voltage input terminal,
wherein a voltage level of the first voltage is greater than a voltage level of the second voltage, and
a voltage level of the third voltage is less than the voltage level of the second voltage.

18. The gate driving circuit of claim 17, wherein each of the plurality of stages further comprises:
a leakage prevention transistor comprising a gate connected to the first node, and comprising a first end connected to the first voltage input terminal and a second end connected to an intermediate node of the first sub-transistors and an intermediate node of the second sub-transistors.

19. The gate driving circuit of claim 17, wherein the second node controller further comprises:
a fourth transistor connected between the first clock terminal and a fourth node, and comprising a gate connected to the first node;
a fifth transistor connected between the first voltage input terminal and the fourth node, and comprising a gate connected to the first clock terminal;
a sixth transistor connected between the fourth node and a fifth node, and comprising a gate connected to the first voltage input terminal;
a capacitor connected between the fifth node and a sixth node;
a seventh transistor connected between a second clock terminal to which a second clock signal is input and the sixth node, and comprising a gate connected to the fifth node;
an eighth transistor connected between the first voltage input terminal and the third node, and comprising a gate connected to the sixth node; and
a ninth transistor connected between the third node and the third voltage input terminal, and comprising a gate connected to the first node,
wherein the first clock signal and the second clock signal repeat a voltage of a first voltage level and a voltage of a second voltage level, and the second clock signal is shifted by a half cycle from the first clock signal.

20. The gate driving circuit of claim 17, wherein each of the plurality of stages further comprises:
a second output unit connected between the first voltage input terminal and the second voltage input terminal, and configured to output the first voltage or the second voltage as a carry signal according to the voltage levels of the second node and the third node.
